(19) United States
(12) Patent Application Publication
(10) Pub. No.: US 2025/0016191 A1
(43) Pub. Date: Jan. 9, 2025

(54) Generating a Security Metric Using a Machine Learning Model

(71) Applicant: Telefonaktiebolaget LM Ericsson (publ), Stockholm (SE)

(72) Inventor: Fereydoun Farrahi Moghaddam, Coquitlam (CA)

(21) Appl. No.: 18/707,738

(22) PCT Filed: Nov. 12, 2021
(86) PCT No.: PCT/IB2021/060489

§ 371 Date: May 6, 2024

(51) Int. Cl. H04L 9/40

(52) U.S. Cl. CPC H04L 63/1433; H04L 63/1425

(57) ABSTRACT

A method (400) for generating a security metric for a target system is disclosed. The security metric provides a quantitative representation of the security of the target system, which representation is non-specific to any given component of the system or point of attack. The method involves generation of an analogical model of the target system (410), and mapping of the analogical model to a directed graph of the target system (430). A distance metric is then calculated (440) between the directed graph of the target system and directed graphs of a plurality of reference systems. The method further comprises inputting a tensor comprising the calculated distance metrics to a trained ML model (450), wherein the ML model has been trained using a training data set that is based on the same plurality of reference systems (450a) and wherein the ML model is operable to process the input tensor and to generate an output comprising a value of the security metric for the target system (450b). Also disclosed is a method (300) for training an ML model to generate a security metric.

### TECHNICAL FIELD

The present disclosure relates to a method for generating a security metric for a target system comprising a plurality of logical components, and to a method for training a Machine Learning (ML) model for generating such a metric. The methods may be performed by a Prediction module and a Training module respectively. The present disclosure also relates to a Prediction module, a Training module, and to a computer program product configured, when run on a computer, to carry out methods for generating a security metric for a target system, and for training an ML model for generating such a metric.

### BACKGROUND

Distributed computing systems are subject to security threats, and a range of different security metrics exist to represent the level of security of a system. A high level ontology of system security metrics is presented in Pendleton, Marcus, Richard Garcia-Lebron, Jin-Hee Cho, and Shouhuai Xu. “A survey on systems security metrics.” ACM Computing Surveys (CSUR) 49, no. 4 (2016): 1-35, and is reproduced as FIG. 1. The four main classes of security metric illustrated in the ontology are:
Vulnerability Metrics, representing a level of system vulnerability, and including for example user vulnerabilities, interface-induced vulnerabilities, and software vulnerabilities;
Defence Metrics, measuring the strength of defence mechanisms in a system, which mechanism may be preventive, reactive, and/or proactive, and all of which may contribute to an overall system defence;
Attack Metrics, measuring the strength of attacks performed against a system, which may include zero-day attacks, targeted attacks, botnets, malware spreading, and evasion techniques; and
Situation Metrics, reflecting the attack-defence interactions with respect to a system. These metrics may include security states, historical security incidents, and historical security investments.

Another analysis tool for assessing the security of a distributed system is an attack graph. An attack graph can be used to simulate the possible paths that may be used by attackers to compromise a system of logical components, such as a computer network or subnet. An attack graph is used to evaluate the security of the system and analyse and predict the behaviour of an attacker. An example network topology and corresponding example attack graph are illustrated in FIGS. 2a and 2b, reproduced from Zeng, Jianping, Shuang Wu, Yanyu Chen, Rui Zeng, and Chengrong Wu. “Survey of Attack Graph Analysis Methods from the Perspective of Data and Knowledge Processing.” Security and Communication Networks 2019. The attack graph in FIG. 2b shows the possible paths by which an attacker can exploit vulnerabilities on certain servers in order to reach a target component of the system illustrated in FIG. 2a. The attack graph refers to Common Vulnerabilities and Exposures (CVEs), which are publicly disclosed and listed security flaws in system components. Through exploiting specific CVEs on the components of the network topology of FIG. 2a, an attacker can gradually obtain access to different levels of system component, until the attacker's aim has been achieved.

The security metrics and attack graph discussed above allow for the evaluation of a range of different aspects of the security of a system, as well as simulation of possible paths of attack. However, calculating and assigning a single metric to represent the overall level of security of a system remains a highly challenging task. As illustrated by the different classes of security metric introduced above, “security” is something of an umbrella term, encompassing many different aspects of a system. The entire question of system security is in addition relatively subjective, with objective measures of security only generally being available through testing protocols such as penetration testing, which can be prohibitively expensive and time consuming, particularly given the dynamic nature of many distributed systems. This lack of objective measures means that it can be extremely difficult to achieve consensus and acceptance of security metrics between vendors and customers.

A majority of approaches for generating an overall metric to represent the security of a system are based on the attack graph concept. However, generating an attack graph requires the definition of a target system component, as well as entry points for attacks. An attack graph is therefore by definition specific to a given combination of target and entry points, and this limits its usefulness as a basis for generating an overall security metric that is not limited to the particular combination on which the attack graph is based.

Similar problems regarding the uncertainty of target components, and how exactly an attacker will seek to exploit vulnerabilities to achieve a given target, can be found in other approaches to generating an overall security metric. For example, it will be appreciated that even in a system which may contain very few vulnerabilities, and so perhaps score highly in terms of a system vulnerability metric, if one of the few vulnerabilities present allows for direct access to the target of a particular attacker, then the entire system may be at risk of compromise as a consequence of that single vulnerability.

### SUMMARY

It is an aim of the present disclosure to provide methods, a Training module, a Prediction module, and a computer readable medium which at least partially address one or more of the challenges mentioned above. It is a further aim of the present disclosure to provide methods, a Training module, a Prediction module, and a computer readable medium which cooperate to facilitate the generation of a security metric that provides a quantitative representation of the security of a target system, and which is non-specific to any given component of the system or point of attack.

According to a first aspect of the present disclosure, there is provided a computer implemented method for training a Machine Learning (ML) model having a plurality of trainable parameters, wherein the ML model is for generating a security metric for a target system comprising a plurality of logical components, and wherein the security metric comprises a quantitative representation of the security of the target system, which representation is non-specific to any given component of the system or point of attack. The method comprises, for each of a plurality of reference systems, and for each of a plurality of training systems, generating an analogical model of the system, the analogical model comprising a plurality of vulnerability resistance elements, each vulnerability resistance element corresponding to a security vulnerability of the modelled system, and mapping the generated analogical model to a directed graph of the modelled system. For each of the plurality of training systems, a value of the security metric is available. The method further comprises, for each of the plurality of training systems, calculating a distance metric between the directed graph of the training system and the directed graph of each of the plurality of reference systems, and adding to a training data set the calculated distance metrics and the security metric value for the training system. The method further comprises using the training data set to update values of the trainable parameters of the ML model, wherein the ML model is operable to receive an input comprising a plurality of distance metrics, and to provide an output comprising a value of the security metric.

According to another aspect of the present disclosure, there is provided a computer implemented method for generating a security metric for a target system comprising a plurality of logical components, wherein the security metric comprises a quantitative representation of the security of the target system, which representation is non-specific to any given component of the system or point of attack. The method comprises generating an analogical model of the target system, the analogical model comprising a plurality of vulnerability resistance elements, each vulnerability resistance element corresponding to a security vulnerability of the target system, and mapping the generated analogical model to a directed graph of the target system. The method further comprises calculating a distance metric between the directed graph of the target system and a directed graph of each of a plurality of reference systems, and inputting a tensor comprising the calculated distance metrics to a trained ML model. The ML model has been trained using a training data set that is based on the same plurality of reference systems; and
the ML model is operable to process the input tensor and to generate an output comprising a value of the security metric for the target system.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a Training module for training an ML model having a plurality of trainable parameters, wherein the ML model is for generating a security metric for a target system comprising a plurality of logical components, and wherein the security metric comprises a quantitative representation of the security of the target system, which representation is non-specific to any given component of the system or point of attack. The Training module comprises processing circuitry configured to cause the Training module to, for each of a plurality of reference systems, and for each of a plurality of training systems, generate an analogical model of the system, the analogical model comprising a plurality of vulnerability resistance elements, each vulnerability resistance element corresponding to a security vulnerability of the modelled system, and map the generated analogical model to a directed graph of the modelled system. For each of the plurality of training systems, a value of the security metric is available. The processing circuitry is further configured to cause the Training module to, for each of the plurality of training systems, calculate a distance metric between the directed graph of the training system and the directed graph of each of the plurality of reference systems, and add to a training data set the calculated distance metrics and the security metric value for the training system. The processing circuitry is further configured to cause the Training module to use the training data set to update values of the trainable parameters of the ML model, wherein the ML model is operable to receive an input comprising a plurality of distance metrics, and to provide an output comprising a value of the security metric.

According to another aspect of the present disclosure, there is provided a Prediction module for generating a security metric for a target system comprising a plurality of logical components, wherein the security metric comprises a quantitative representation of the security of the target system, which representation is non-specific to any given component of the system or point of attack. The Prediction module comprises processing circuitry configured to cause the Prediction module to generate an analogical model of the target system, the analogical model comprising a plurality of vulnerability resistance elements, each vulnerability resistance element corresponding to a security vulnerability of the target system. The processing circuitry is further configured to cause the Prediction module to map the generated analogical model to a directed graph of the target system, and calculate a distance metric between the directed graph of the target system and a directed graph of each of a plurality of reference systems. The processing circuitry is further configured to cause the Prediction module to input a tensor comprising the calculated distance metrics to a trained ML model. The ML model has been trained using a training data set that is based on the same plurality of reference systems, and the ML model is operable to process the input tensor and to generate an output comprising a value of the security metric for the target system.

Aspects of the present disclosure thus provide methods and modules that enable the generation of a security metric that comprises a quantitative representation of the security of a target system, and which representation is non-specific to any given component of the system or point of attack. The metric is based on comparison of a representation of security vulnerabilities in the target system to a corresponding representation of one or more reference systems. The representation of security vulnerabilities is generated using an analogical model, which may then be mapped to a directed graph of the system, allowing for the use of graph distance metrics to generate input features for an ML model. The use of an analogical model and directed graph avoids the need to define a specific target component of the system and specific attack entry points, ensuring that the generated metric applies to the entire system, and is nonspecific to a given target or point of attack.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates a high level ontology of system security metrics;

FIGS. 2a and 2b show an example network topology and corresponding example attack graph;

FIG. 3 is a flow chart illustrating process steps in a computer implemented method for training an ML model having a plurality of trainable parameters;

FIG. 4 is a flow chart illustrating process steps in a computer implemented method for generating a security metric for a target system comprising a plurality of logical components;

FIG. 5 illustrates an example network system scenario, with security conditions linked by known security vulnerabilities;

FIG. 6 illustrates an analogical model of the scenario in FIG. 5, using the electrical domain;

FIGS. 7a to 7e show flow charts illustrating another example of a method for training an ML model having a plurality of trainable parameters;

FIGS. 8a to 8g show flow charts illustrating another example of a method for generating a security metric for a target system comprising a plurality of logical components;

FIG. 9 is a block diagram illustrating functional modules in an example Training module;

FIG. 10 is a block diagram illustrating functional modules in another example Training module;

FIG. 11 is a block diagram illustrating functional modules in an example Prediction module;

FIG. 12 is a block diagram illustrating functional modules in another example Prediction module;

FIG. 13 illustrates a selection process for identifying suitable systems to be included within a plurality of reference systems;

FIG. 14 illustrates process steps in feature engineering for generating an input tensor;

FIG. 15 illustrates process steps for building and training an ML model;

FIG. 16 illustrates ML model validation;

FIG. 17 illustrates use of a trained ML model to generate a value of a security metric for a target system;

FIG. 18 illustrates analogical models of three different systems;

FIG. 19 illustrates an attack graph and two analogical models of a system;

FIG. 20 shows a system with a main part and two subsystems for which no configuration data is available; and

FIG. 21 shows the system of FIG. 20 with the subsystems represented in the analogical model.

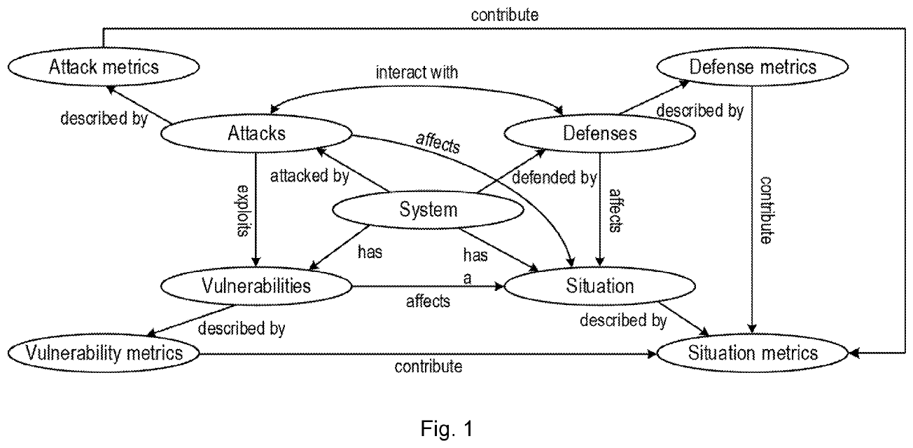

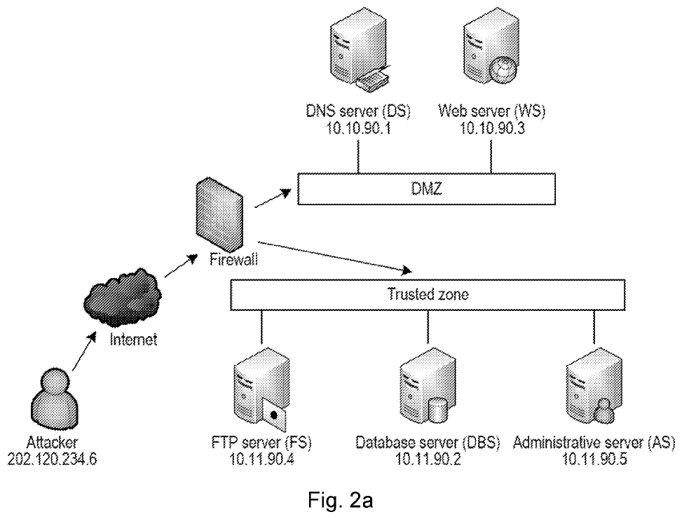

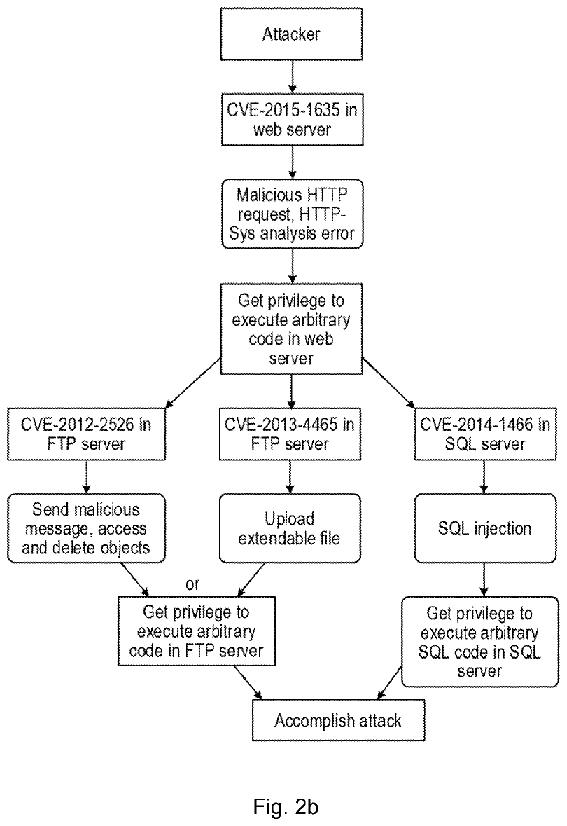

### DETAILED DESCRIPTION

Examples of the present disclosure propose a data driven approach to the challenge of generating an overall security metric for a system comprising a plurality of logical components. The proposed approach addresses the above discussed problems of subjectivity and specificity of existing methods, and provides a quantitative representation of system security based on comparison to reference systems, and using a plurality of training systems for which a value of an overall metric is available. The security metric value for the training systems may be provided for example through penetration testing or following detailed analysis by suitable domain experts. As discussed above, such testing or analysis is impractical for wide scale use, particularly in dynamic systems, but may be available for a certain number of training systems. The training systems, their comparison to reference systems, and their security metric values may be used to train an ML model to generate a value of a security metric for a target system based on its comparison to the reference systems. The approach proposed in the present disclosure encompasses aspects of security that are covered in the Vulnerability, Defence, and Attack metrics described in the Background section. The use of an ML model and objective data for training systems assists with providing a metric that can be both evaluated and accepted by different vendors and customers of systems and system components.

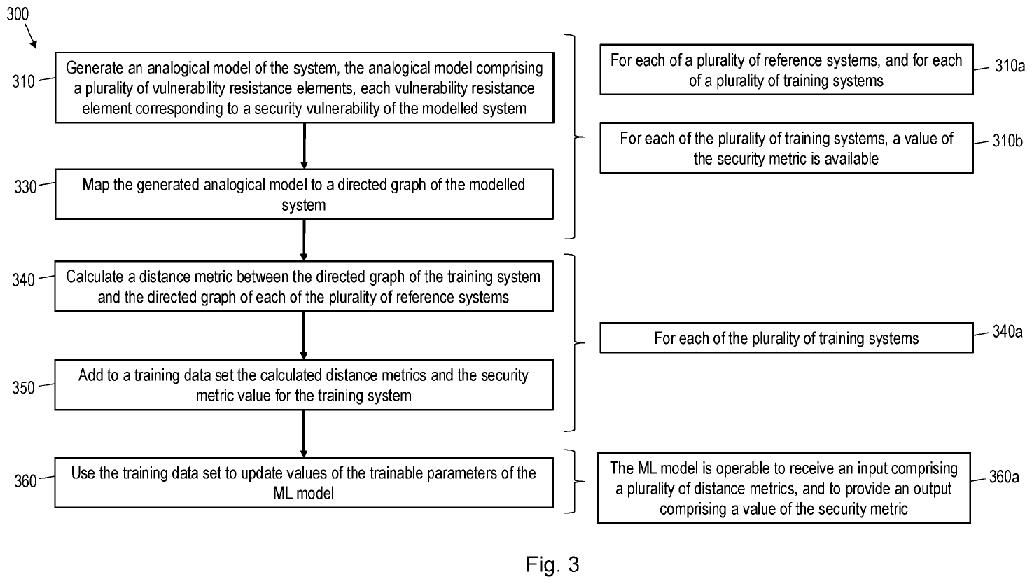

FIG. 3 is a flow chart illustrating process steps in a computer implemented method 300 for training a Machine Learning (ML) model having a plurality of trainable parameters. The ML model is for generating a security metric for a target system comprising a plurality of logical components, and the security metric comprises a quantitative representation of the security of the target system, which representation is non-specific to any given component of the system or point of attack. The method may be performed by a Training module, which may be a virtual function and may be instantiated in a cloud based deployment. In one example, the Training module may be instantiated in a Network Functions Virtualization (NFV) Security Manager node, an example of which is illustrated in “Network Functions Virtualisation (NFV) Release 3, Security, Security Management and Monitoring specification” ETSI GS NFV-SEC 013 V3.1.1 (2017-02). In other examples, the Training module may be instantiated in a physical or virtual server in a centralised or cloud based deployment.

Referring to FIG. 3, the method 300 comprises performing steps 310 and 330 for each of a plurality of reference systems, and for each of a plurality of training systems, as illustrated at 310a. Step 310 comprises generating an analogical model of the reference or training system, the analogical model comprising a plurality of vulnerability resistance elements, each vulnerability resistance element corresponding to a security vulnerability of the modelled system. Step 330 comprises mapping the generated analogical model to a directed graph of the modelled system. As illustrated at step 310b, for each of the plurality of training systems, a value of the security metric is available. This value may for example have been generated using penetration or other system testing, or though expert analysis.

The method 300 further comprises performing steps 340 and 350 for each of the plurality of training systems, as illustrated at step 340a. Step 340 comprises calculating a distance metric between the directed graph of the training system and the directed graph of each of the plurality of reference systems. Step 350 comprises adding to a training data set the calculated distance metrics and the security metric value for the training system. The method further comprises, at step 360, using the training data set to update values of the trainable parameters of the ML model. As illustrated at step 360a, the ML model is operable to receive an input comprising a plurality of distance metrics, and to provide an output comprising a value of the security metric.

The method 300 thus enables training of an ML model that will generate a security metric for a target system based on the relationship of the target system to a plurality of reference systems. The ML model is trained using training systems for which a value of the metric is available, allowing the ML model to learn how relationship to the reference systems correlates with value of the security metric, and so to generate values of the security metric for target systems based only on their relationship to reference systems. The ability of the analogical model and mapped directed graph to represent the reference and training systems ensures that the functional similarity of the reference and training systems is accurately captured by the distance metric between the directed graphs. In this manner, the reference and training systems together provide a benchmark for generating security metrics for target systems. The security metric values generated by the ML model are based on the relationship of the target system to the reference systems, and on the available values of the security metric for the training systems; they are consequently of the same degree of generality and reliability as the security metric values for the training systems.

The method 300 thus produces a trained ML model that generates a security metric in an automated and repeatable manner, and is consequently applicable across vendors, system types etc. The metric can be used for comparing and evaluating different systems regardless of their structure or origin. In addition, owing to the analogical model and its mapping to a directed graph, the generated metric is able to encompass overall system security, without being specific to any given target or point of attack. The use of reference systems to generate the security metric affords considerable flexibility, and the nature of the metric generated by the model will depend directly on the nature of the metrics available for the training systems. As discussed above, the metrics for the training systems may be generated based on expert analysis, penetration testing, or any other suitable method. Thus, as methods and consensus regarding practical and analytic generation of security metrics evolve, the predictions of a model trained or retrained using the method 300 can evolve concurrently. It will be appreciated that the method 300 does not require access to a live run time system in order to generate an analogical model, and the method may consequently be run in any centralised or cloud based deployment.

The method 300 may be complemented by a method 400 performed by a Prediction module, in which method the trained ML model is used for generating a security metric for a target system.

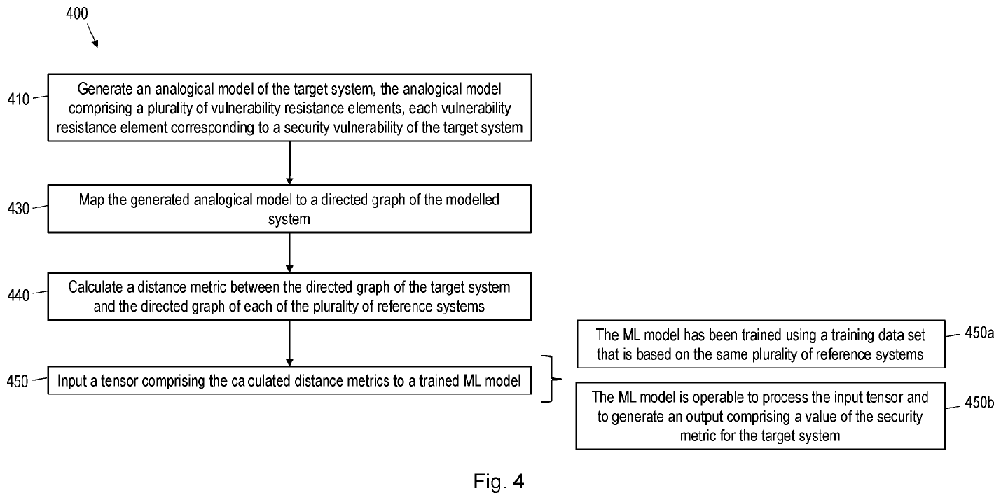

FIG. 4 is a flow chart illustrating process steps in a method 400 for generating a security metric for a target system comprising a plurality of logical components. The security metric comprises a quantitative representation of the security of the target system, which representation is non-specific to any given component of the system or point of attack. The method is performed by a Prediction module, which may be a virtual function and may be instantiated for example in a cloud based deployment. In one for example, the Prediction module may be instantiated in a Network Functions Virtualization (NFV) Security Manager node, an example of which is illustrated in “Network Functions Virtualisation (NFV) Release 3, Security, Security Management and Monitoring specification” ETSI GS NFV-SEC 013 V3.1.1 (2017-02). For example, the method 400 may be run as a service in a Security Manager node. In other examples, the Prediction module may be instantiated in a physical or virtual server in a centralised or cloud based deployment.

Referring to FIG. 4, the method 400 comprises, in step 410, generating an analogical model of the target system, the analogical model comprising a plurality of vulnerability resistance elements, each vulnerability resistance element corresponding to a security vulnerability of the target system. The method 400 further comprises, in step 430, mapping the generated analogical model to a directed graph of the target system, and calculating a distance metric between the directed graph of the target system and a directed graph of each of a plurality of reference systems in step 440. Finally, in step 450, the method 400 comprises inputting a tensor comprising the calculated distance metrics to a trained ML model. As illustrated at 450a, the ML model has been trained using a training data set that is based on the same plurality of reference systems. As illustrated at 450b, the ML model is operable to process the input tensor and to generate an output comprising a value of the security metric for the target system.

It will be appreciated that, as for the method 300, the method 400 does not require access to a live run time system in order to generate an analogical model, and the method may consequently be run in any centralised or cloud based deployment.

For the purposes of the present disclosure, a system comprising a plurality of logical components may include any computing system, distributed or centralised, and may for example comprise a computing network, subnet, part or all of a telecommunications network, cloud based system, data centre, commercial or enterprise network, private network, etc. In the context of telecommunications network, the system may comprise all or part of a Core network, Radio Access Network, etc. A logical component of the system may comprise any physical or virtual server, or a service or control component. A service component may for example comprise a microservice. The system may comprise a plurality of such microservices, which may be grouped into one or more services, such as a Virtualized Network Function (VNF). The system may further comprise one or more service chains comprising a plurality of VNFs, and may in some examples comprise one or more slices including multiple service chain and control components.

In will be appreciated that a security metric that is nonspecific to any given component of the system or point of attack is a security metric whose value is not tied to a particular target component, point of attack, or any combination thereof. Thus, the security metric is representative of a global level of security of the system, regardless of what component may be targeted by an attacker, or from where they may commence their attack. For example, in a cloud based system, typical points of entry for an attack would include endpoints of the system, and the security metric generated according to methods of the present disclosure is representative of the security of the system regardless of the particular endpoint or endpoints from which an attack is launched, or of the particular system component or components that are the target of the attack.

The method 300 trains an ML model, and the method 400 uses an ML model trained to generate a security metric for a target system. For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

In some examples, the ML model trained by the method 300 and used in the method 400 may comprise a regression model. A detailed survey of regression methods is provided in Fernández-Delgado, M., M. S. Sirsat, Eva Cernadas, Sadi Alawadi, Senén Barro, and Manuel Febrero-Bande. “An extensive experimental survey of regression methods.” Neural Networks 111 (2019): 11-34. The above reference identifies 19 families of regression models, including: linear and generalized linear models, generalized additive models, least squares, projection methods, LASSO and ridge regression, Bayesian models, Gaussian processes, quantile regression, nearest neighbours, regression trees and rules, random forests, bagging and boosting, neural networks, deep learning, and support vector regression. The survey identifies several outstanding regression models including: the M5 rule-based model with corrections based on nearest neighbours (cubist), the gradient boosted machine (gbm), the boosting ensemble of regression trees (bstTree) and the M5 regression tree. Other well performing regression models identified are the committee of neural networks (avNNet), extremely randomized regression trees, random forest (rf) and ε-support vector regression (svr), least angle regression lars, and non-negative least squares (nnls). These well performing models offer different advantages in terms of squared correlation, speed, suitability for different datasets, and memory requirements. It is envisaged that, according to the particularities of individual use cases, one or more of these models would be suitable for implementing methods according to the present disclosure.

According to examples of the present disclosure, the plurality of reference systems and plurality of training systems comprise disjoint sets, such that no system can be both a reference and a training system. Also according to examples of the present disclosure, the analogical models of each of the plurality of reference systems and of each of the plurality of training systems use the same physical domain to represent the systems (electrical, mechanical linear, mechanical rotational, hydraulic, etc.). Similarly, the analogical models of each of the plurality of reference systems and of the target system of the method 400 may use the same physical domain to represent the systems. Analogical models and the different physical domains which may be used to represent a system are discussed in greater detail below.

An analogical model of a target system comprises a representation of the target system in a different physical domain to that of the target system. The physical domain of the analogical model may for example be more intuitively understandable, or more easily analysable than the domain of the target system. An analogical model may in some examples seek to preserve topological connections between components of the modelled system, by identifying analogous variables that are measured across a component, and analogous variables that flow through a component. In the context of the present disclosure, an analogical model of a system of logical components may model a flow of attacks through system security vulnerabilities as a flow of some physical variable through one or more resistance variables. For example, in the electrical domain, a flow of attacks through system security vulnerabilities may be modelled as a flow of current through a series of resistors. In the hydraulic domain, a flow of attacks through system security vulnerabilities may be modelled as a flow of liquid through a series of valves. Similar analogies may be found in both linear and rotational mechanical domains.

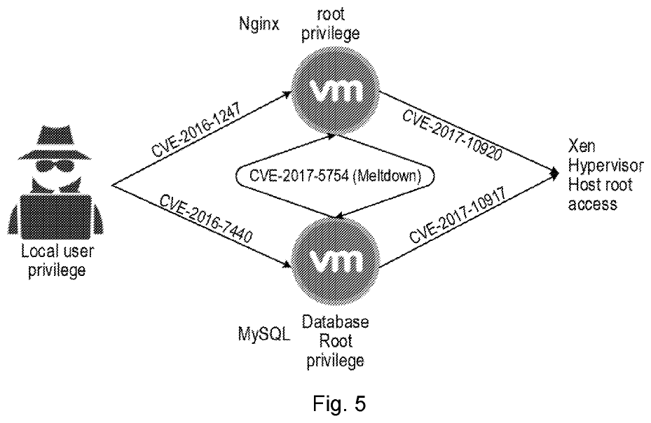

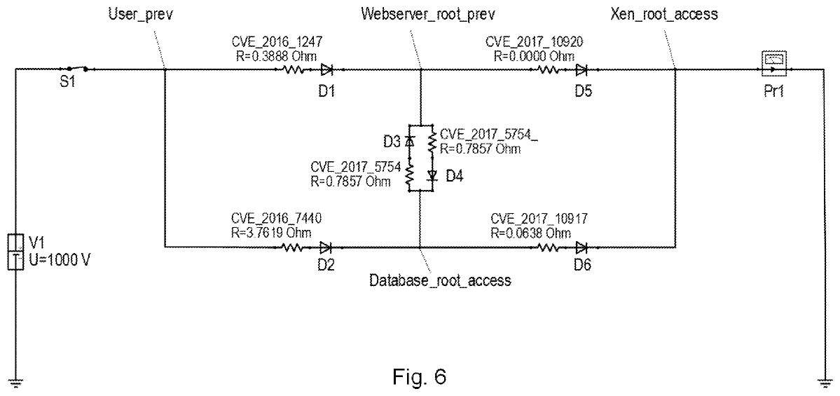

It has been proposed in an internal reference document to model system vulnerabilities as an electrical circuit, referred to as an “attack circuit”, with electrical resistors representing security vulnerabilities. Powering the attack circuit and solving for current flow at different parts of the circuit may enable modelling of security risk for certain security conditions in the system. FIG. 5 illustrates an example network system scenario, with security conditions linked by known security vulnerabilities indicated using their CVE number. FIG. 6 illustrates an analogical model of the scenario in FIG. 5, using the electrical domain. Each CVE of the scenario in FIG. 5 is modelled by a resistor in the attack circuit of FIG. 6, with one way diodes providing directionality to the vulnerabilities. In the case of a pair of vulnerabilities connecting the same conditions in different directions, or in the case of a bidirectional vulnerability, a pair of parallel resistors with differently oriented diodes is used. A voltage source represents an attack entry point, with an earth connection adjacent to the target of an attack and providing directionality to the current flow. Measuring current at the attack target provides an indication of the security risk to the target of an attack from the selected entry point or points.

As will be discussed in greater detail below, the electrical domain discussed above is one option for the analogical model for the methods of the present disclosure. However, regardless of the domain selected for the analogical model, it is in the mapping of the analogical model to a directed graph that the specificities of the attack circuit described above with respect to target component and attack entry points can be broadened to provide a representation of security of the entire system.

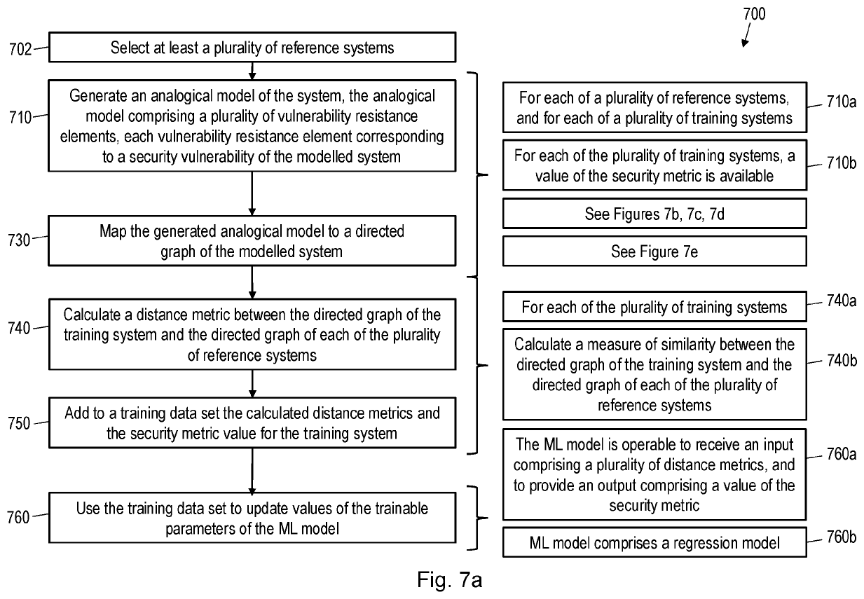

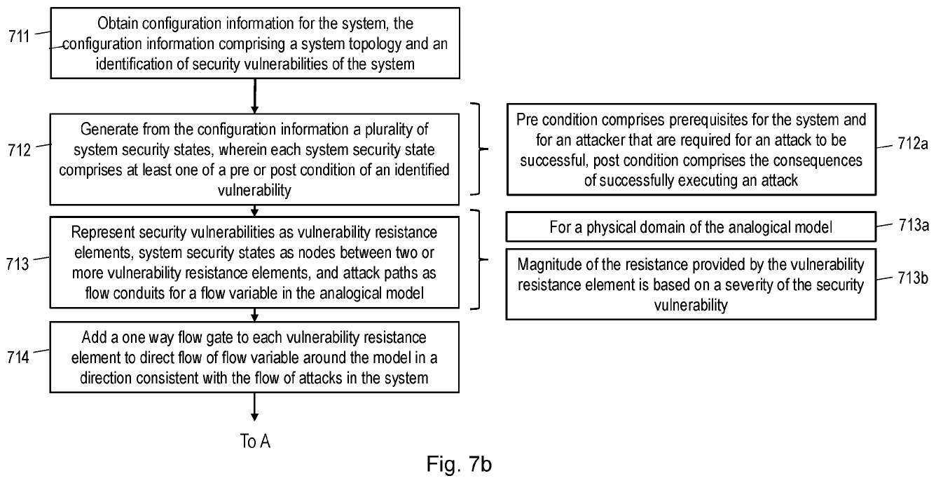

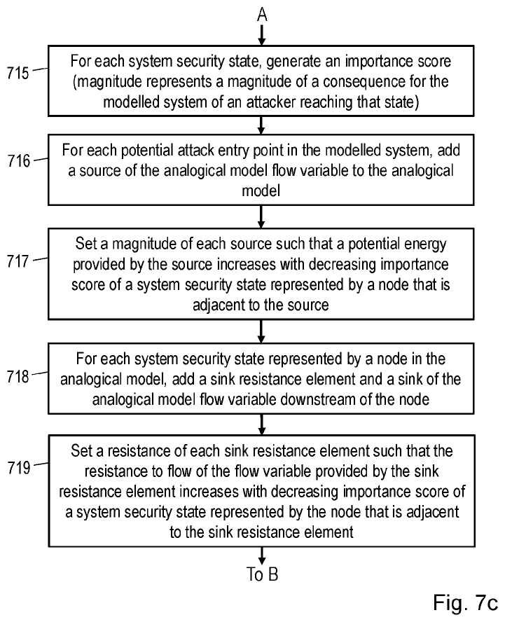

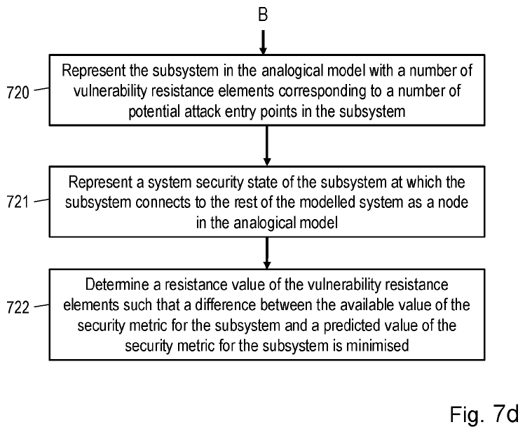

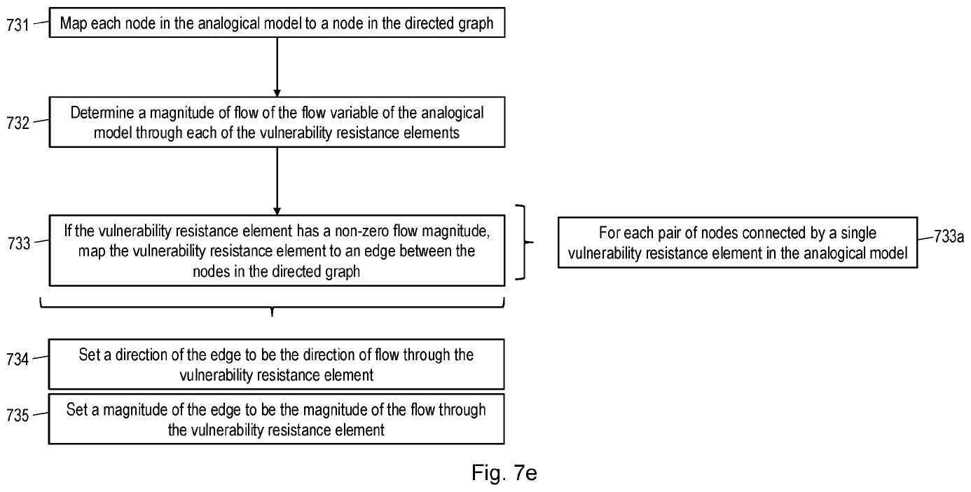

FIGS. 7a to 7e show flow charts illustrating another example of a method 700 for training an ML model having a plurality of trainable parameters. As for the method 300 discussed above, the ML model is for generating a security metric for a target system comprising a plurality of logical components, and wherein the security metric comprises a quantitative representation of the security of the target system, which representation is non-specific to any given component of the system or point of attack. The method 700 may be performed by a Training module, which may be operable to be instantiated in a cloud based deployment. In one for example, the Training module may be instantiated in a Network Functions Virtualization (NFV) Security Manager node, an example of which is illustrated in “Network Functions Virtualisation (NFV) Release 3, Security, Security Management and Monitoring specification” ETSI GS NFV-SEC 013 V3.1.1 (2017-02). In other examples, the Training module may be instantiated in a physical or virtual server in a centralised or cloud based deployment._{[GR1]} The method 700 illustrates examples of how the steps of the method 300 may be implemented and supplemented to provide the above discussed and additional functionality.

Referring initially to FIG. 7a, in a first step 702, the training module may select at least a plurality of reference systems such that the plurality fulfils a diversity criterion with respect to the domain of systems for which the trained ML model is to be used. The diversity criterion could be expressed in a range of ways that ensure the reference set is representative of the search space of the relevant domain. For example, if the target systems are to be cloud based systems providing one or more services to enterprise customers, then the diversity criterion may be constructed to ensure that the plurality of reference systems is representative of the range of deployment options, system size and complexity, service sectors, access requirements etc that may be encountered in the target systems. The plurality of reference systems may also be selected at step 702 such that individual systems in the plurality fulfil a significance criterion with respect to the domain of systems for which the trained ML model is to be used. The significance criterion may ensure that no system in the plurality of reference systems is an outlier in terms of any system feature that is particularly relevant, for example being significantly smaller than typical systems in the domain of interest, or having significantly different requirements for performance or access. If a security metric value is available for the reference systems, then the plurality of reference systems may also be selected at step 702 such that individual systems in the plurality fulfil a consensus criterion with respect to the value of the security metric that is available for individual systems. The consensus criterion might for example require values of a security metric to be available that have been generated by penetration testing according to a particular testing regime, or might specify particular expert driven methods that are acceptable for generation of a security metric.

In some examples, the training module may select a plurality of training systems at step 702 using the same criteria regarding diversity of the plurality of training systems, and significance and consensus regarding the available security metric for individual training systems, all with respect to the domain of systems for which the trained ML model is to be used.

It will be appreciated that while a value for the security metric is available for the training systems, such a value may or may not be available for the reference systems. If available, the security metric value for the reference systems is not required to train the ML model. Training uses the comparison of the training systems to the reference systems (the distance metric for the directed graphs) and the security metric value for the training systems. When the ML model is used, the relationship of a target system (distance metric) to the reference systems serves to locate the target system in the search space, however it is the training systems that provide the information about actual security metric values during the training process. The ML model learns a correlation between location in the search space with respect to the reference systems, and security metric value. If a value for the security metric is available for the reference systems, then this may be used to help ensure the reference systems fulfil the diversity and consensus criteria discussed above.

The Training module then conducts steps 710 and 730 for each of the plurality of reference systems, and for each of the plurality of training systems, as illustrated at step 710a. Step 710 comprises generating an analogical model of the system, the analogical model comprising a plurality of vulnerability resistance elements, each vulnerability resistance element corresponding to a security vulnerability of the modelled system. Step 730 comprises mapping the generated analogical model to a directed graph of the modelled system. As illustrated at step 710b, for each of the plurality of training systems, a value of the security metric is available, which value may have been generated by penetration testing, expert analysis, or any other selected method.

For the purposes of the present disclosure, a security vulnerability may comprise a weakness or flaw in the computational logic or code of a software or hardware component. This weakness or flaw, when exploited, is operable to result in a negative impact on the confidentiality or integrity of the component, or to provide availability to the component or to other components via the compromised component. Security vulnerabilities may be publicly disclosed as Common Vulnerabilities and Exposures (CVEs) or via other public disclosure platforms such as the U.S. government's National Vulnerability Database (NVD). A security vulnerability is generally directional, with a bidirectional security vulnerability being essentially an aggregation of two directed security vulnerabilities, in which each security vulnerability may have a different degree of severity or resistance to exploitation. For example, considering two servers with root privileges states, it may be easier to hack the server with a lower kernel version from a position of having access to the server with a higher kernel version, but the hacking (or exploitation) is possible in both directions.

Steps that may be performed in order to carry out the generation of an analogical model at step 710 are illustrated in FIGS. 7b, 7c and 7d, and steps that may be performed in order to map the analogical model to a directed graph in step 730 are illustrated in FIG. 7e.

Referring initially to FIG. 7b, in order to generate an analogical model of a reference or training system in step 710, the Training module may initially obtain configuration information for the system in step 711, the configuration information comprising a system topology and an identification of security vulnerabilities of the system. The Training module may then generate from the configuration information a plurality of system security states in step 712, wherein each system security state comprises at least one of a pre or post condition of an identified vulnerability. As illustrated at 712a, a pre condition of a security vulnerability comprises prerequisites for the system and for an attacker that are required for an attack on the security vulnerability to be successful, and a post condition of a security vulnerability comprises the consequences for the system and for the attacker of successfully executing an attack on the security vulnerability. Pre and post conditions may specify any one or more of resources, connectivities and/or privileges to which an attacker must have access prior to an attack on the vulnerability, or to which an attacker gains access following an attack on the vulnerability. The post condition from one vulnerability may be the pre condition for another vulnerability. For example, the post condition of compromising one component may be gaining access to another component, without which access a further vulnerability cannot be exploited.

In step 713, the Training module may, for a physical domain of the analogical model as illustrated at step 713a, represent the identified security vulnerabilities, generated system security states, and attack paths traversing vulnerabilities between system security states as follows. As discussed above, the physical domain of the analogical model may be electrical, hydraulic, linear or rotational mechanical, etc.

Each identified security vulnerability of the system may be represented as a vulnerability resistance element of the analogical model, that is an electrical resistor, a flow valve, a mechanical damper, etc. As illustrated at step 713b, a magnitude of the resistance provided by the vulnerability resistance element may be based on a severity of the security vulnerability. Severity of a security vulnerability may encompass both resilience to attack and impact of the vulnerability being exploited, as in the widely used Common Vulnerability Scoring System (CVSS) for example. It will be appreciated that severity in this sense is generic to the vulnerability and thus not necessarily representative of a consequence of the vulnerability being exploited in the specific modelled system. This system specific consequence will depend upon the particular topology of the modelled system, and is encompassed in an importance score that may be assigned to specific security states, as discussed in greater detail below.

Each generated system security state may be represented as a node between two or more vulnerability resistance elements of the analogical model. A node of the analogical model can thus be envisaged as a flow connector of a flow variable appropriate for the physical domain of the analogical model (electrical connector, hydraulic connector, mechanical connector etc).

Attack paths traversing vulnerabilities between system security states may be represented as flow conduits for a flow variable in the analogical model (electrical wire, hydraulic pipe, mechanical element capable of transmitting force or torque, etc.).

In step 714, the Training module may add a one way flow gate (diode, one way valve, etc) to each vulnerability resistance element to direct flow of a flow variable around the model in a direction consistent with the flow of attacks in the system. As discussed above, bidirectional security vulnerabilities may be represented in the analogical model by two unidirectional vulnerability resistance elements, each vulnerability resistance element associated with a one way gate directing flow in the direction of the vulnerability with respect to an attack (resistor and diode, etc).

Referring now to FIG. 7c, in step 715, the Training module may, for each system security state represented in the analogical model, generate an importance score, wherein a magnitude of the importance score represents a magnitude of a consequence for the modelled system of an attacker reaching that state. In some examples, the importance scores can be normalised to within a range: 0 to 1 or 0 to 10 for example. The importance score can be at least partially generated using the system topology from the configuration information obtained at step 711, such that a magnitude of the consequence of an attacker reaching a state is at least partially based on the connectivity of that state, i.e. what vulnerabilities and potential other system security states can be accessed from the state if it is reached by an attacker.

A simple example may be envisaged in which a system has two components: a database and a logger, each component having one security vulnerability. The database vulnerability could have a relatively low vulnerability score, indicating that the vulnerability is not overly severe, for example because the vulnerability is difficult to exploit. The security vulnerability of the logger may have a higher vulnerability score, indicating a relatively severe vulnerability owing to the ease with which the vulnerability may be exploited to hack the logger component. However, the importance score for system security states is not related to the severity of the security vulnerabilities by which those states may be reached, but rather the consequence for the modelled system of an attacker reaching that state. Considered in these terms, exploiting the logger security vulnerability to gain access to the logger component has only very minor consequences for the system; it is essentially a dead-end for an attacker when considering the damage that it can cause the modelled system. In contrast, gaining access to the database component would have much more significant consequences for the modelled system, and consequently the importance score for the system security state associated with access to the database is set to be far higher than the importance score of the system security state associated with access to the logger component.

In step 716, the Training module adds a source of the analogical model flow variable to the analogical model for each potential attack entry point in the modelled system. This may comprise adding a source of the flow variable to each system security state represented by a node in the analogical model, for example if each system security state represents a potential attack entry point. The source of flow variable may be a source of electrical current, a source of liquid flow, a source of force or torque, etc. A source is added at each potential attack entry point for the system. Each source of flow variable may be associated with a source resistance element. The Training module then, in step 717, sets a magnitude of each source such that a potential energy provided by the source increases with decreasing importance score of a system security state represented by a node that is adjacent to the source. In some examples, the magnitude of the source (i.e., the potential energy provided by the source in the form of voltage, pressure etc), may be inversely proportional to the importance score, or may have some other relation that fulfils the relationship of increasing potential energy with decreasing importance score of the system security state represented by the adjacent node.

For each system security state represented by a node in the analogical model, the Training module adds a sink resistance element and a sink of the analogical model flow variable downstream of the node in step 718. The sink may for example be an earth connection, a liquid tank, etc. In step 719, the Training module sets a resistance of each sink resistance element such that the resistance to flow of the flow variable provided by the sink resistance element increases with decreasing importance score of a system security state represented by the node that is adjacent to the sink resistance element.

It will be appreciated that steps 716 to 719 effectively involve considering every system security state as a potential target of an attack, and every potential attack entry point as an entry point of an attack. The analogical model is thus organised so as to represent security vulnerabilities of the entire system, and not just one potential point of attack and target state.

Referring now to FIG. 7d, at least one of the plurality of reference systems or the plurality of training systems may comprise a subsystem for which a value of the security metric is available. It is possible that the network topology or other configuration information for such a subsystem may be unavailable, and consequently the subsystem may be represented in the analogical model in the following manner. In step 720, the Training module may represent the subsystem in the analogical model with a number of vulnerability resistance elements corresponding to a number of potential attack entry points in the subsystem. In step 721, the Training module may represent a system security state of the subsystem at which the subsystem connects to the rest of the modelled system as a node in the analogical model. Finally, at step 722, the Training module may determine a resistance value of the vulnerability resistance elements for the subsystem such that a difference between the available value of the security metric for the subsystem and a predicted value of the security metric for the subsystem is minimised. The predicted value may be generated using a previous or current version of the ML model being trained.

As discussed above, for each of the plurality of reference systems and each of the plurality of training systems, following generation of an analogical model at step 710, the Training module then maps the generated analogical model to a directed graph of the modelled system in step 730. Steps that may be performed in order to map the analogical model to a directed graph in step 730 are illustrated in FIG. 7e.

Referring to FIG. 7e, in step 731, the Training module first maps each node in the analogical model to a node in the directed graph. The Training module then determines a magnitude of flow of the flow variable of the analogical model through each of the vulnerability resistance elements in step 732. This may be determined using appropriate equations for the physical domain of the analogical model, and based on the sources and sinks of the relevant flow variable, and resistance values of the vulnerability and sink resistance elements. In step 733, for each pair of nodes connected by a single vulnerability resistance element in the analogical model (as illustrated at 733a), if the vulnerability resistance element connecting the pair of nodes has a non-zero flow magnitude, the Training module maps the vulnerability resistance element to an edge between the nodes in the directed graph. If the vulnerability resistance element between two nodes has no flow of the appropriate flow variable through it (i.e., no current or liquid flow, no force or torque), then no edge is created between the nodes in the mapped directed graph. The sink resistance elements are thus also not represented in the directed graph, as they do not connect a pair of nodes. However, the sink resistance elements, and their resistance values, help to determine the flow of the flow variable through the vulnerability resistance elements, and consequently whether or not, and with what weight and direction, an edge is created in the directed graph between each pair of nodes. As illustrated at steps 734 and 735, the Training module sets a direction of the mapped edge to be the direction of flow through the corresponding vulnerability resistance element, and sets a magnitude of the edge to be the magnitude of the flow through the vulnerability resistance element.

It will be appreciated that the mapping process illustrated in FIG. 7e helps to ensure that the directed graph represents the flow of attacks through the system, and not just the topology of the analogical model, and consequently the security vulnerabilities of the modelled system. The analogical model, with the introduction of sources at all potential attack entry points, and sinks adjacent to all system security states (and consequently all potential targets), represents the possible flow of attacks. The resistance values, being determined based on importance scores for the particular system, direct the flow of attacks in accordance with system specific consequences of a particular system security state being compromised. Solving for flow of the flow variable on this basis, and using flow through the vulnerability resistance elements to determine the presence, direction, and magnitude of edges in the directed graph, enables the directed graph to provide an indication of the magnitude of flow of attacks that may be experienced and to what extent they may succeed. This provides an informative basis for comparison between target and reference systems for the purpose of generating a security metric representing the overall security level of the system.

Referring again to FIG. 7a, following generation of an analogical model and mapping of the model to a directed graph for each of the plurality of reference systems and each of the plurality of training systems, the Training module then performs steps 740 and 750 for each of the plurality of training systems, as illustrated at step 740a.

In step 740, the Training module calculates a distance metric between the directed graph of a training system under consideration and the directed graph of each of the plurality of reference systems. In step 750, the Training module adds to a training data set the calculated distance metrics and the security metric value for the training system.

As illustrated at step 740b, calculating a distance metric between the directed graph of the training system and the directed graph of each of the plurality of reference systems may comprise calculating a measure of similarity between the directed graph of the training system and the directed graph of each of the plurality of reference systems. The measure of similarity may return a scalar for each distance or may return a multidimensional distance, according to the process used to calculate the similarity. A wide range of graph similarity measurement processes is available, including as set out in Zager, Laura A., and George C. Verghese. “Graph similarity scoring and matching” Applied mathematics letters 21, no. 1 (2008): 86-94, and in Zager, Laura. “Graph similarity and matching” PhD diss., Massachusetts Institute of Technology, 2005. The first of the above referenced papers outlines a class of graph similarity measures that uses the structural similarity of local neighbourhoods to derive pairwise similarity scores for the nodes of two different graphs, and presents a related similarity measure that uses a linear update to generate both node and edge similarity scores. This measure is then applied to the task of graph matching. The second of the above referenced papers introduces a similarity measure that uses a linear update to generate both node and edge similarity scores and has desirable convergence properties. It will be appreciated that while the similarity measures set out in the above referenced papers are examples of measures that may be used for the step 740b, other distance metrics between the directed graphs of the training systems and the directed graphs of the reference systems may be envisaged.

Referring still to FIG. 7a, and as discussed above, for each training system, after calculating the distance metrics to each reference system, the Training module adds to a training data set the calculated distance metrics and the security metric value for the training system in step 750.

In step 760, the Training module uses the training data set to update values of the trainable parameters of the ML model. As discussed above, the ML model may be a regression model, as illustrated at 760b, and is operable to receive an input comprising a plurality of distance metrics, and to provide an output comprising a value of the security metric, as illustrated at 760a. Using the training data set to update values of the trainable parameters of the ML model may for example comprise, for systems in the plurality of training systems:
inputting the distance metric for the training system to the ML model;
obtaining an output comprising a predicted value of the security metric for the training system;
calculating a loss function based on the predicted value of the security metric and the value from the training data set; and
seeking to minimise the loss function by updating parameters according to one or more optimisation functions.

The output of the method 700 is a trained ML model that may be used to generate a security metric for a target system, for example according to the method 400 of FIG. 4.

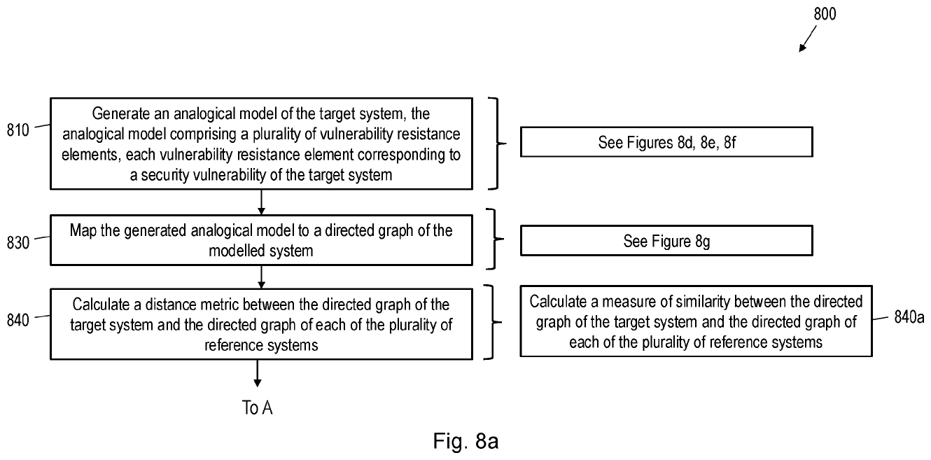

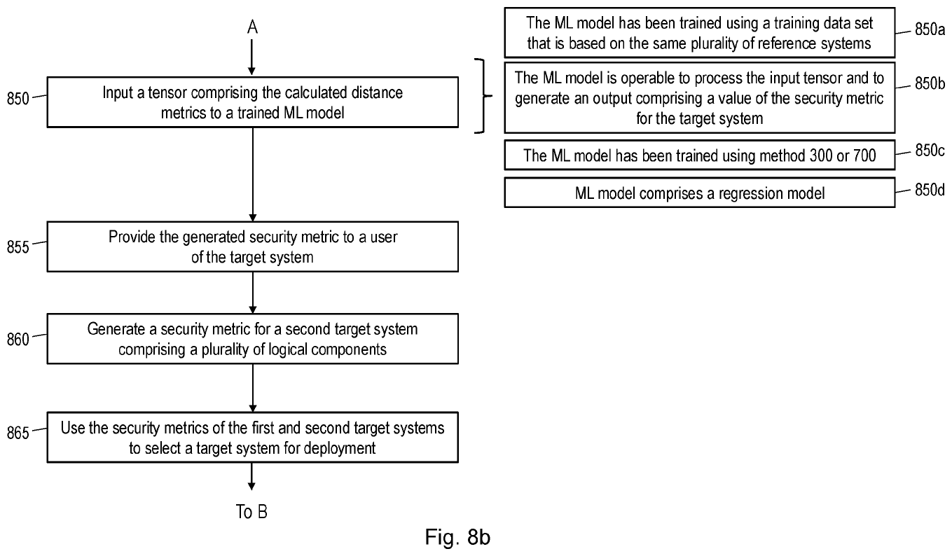

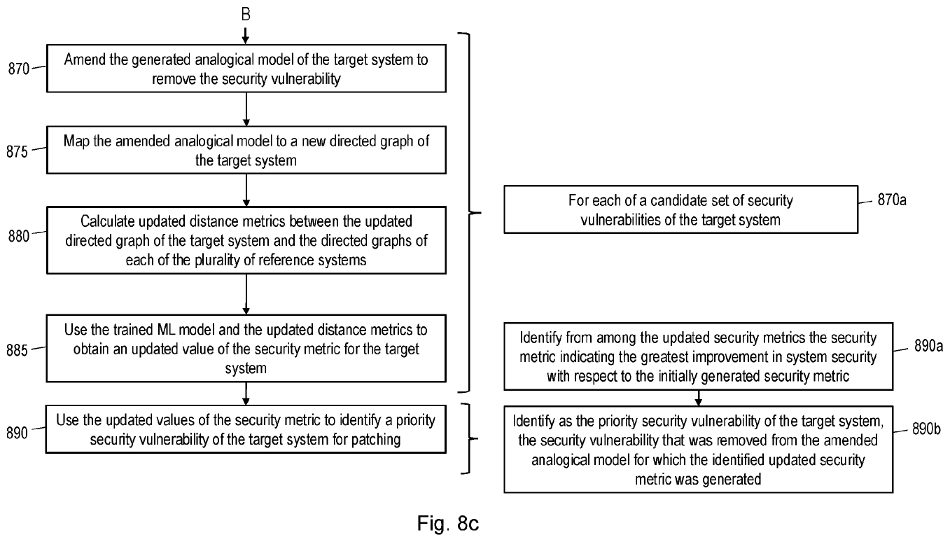

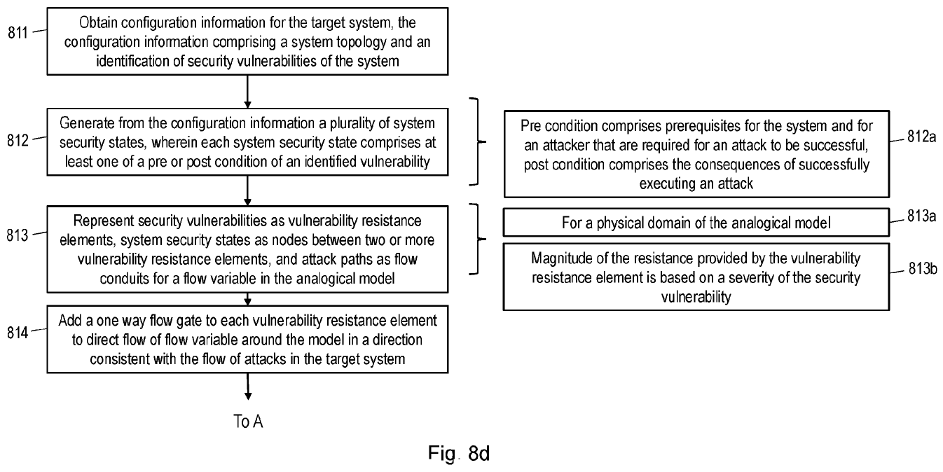

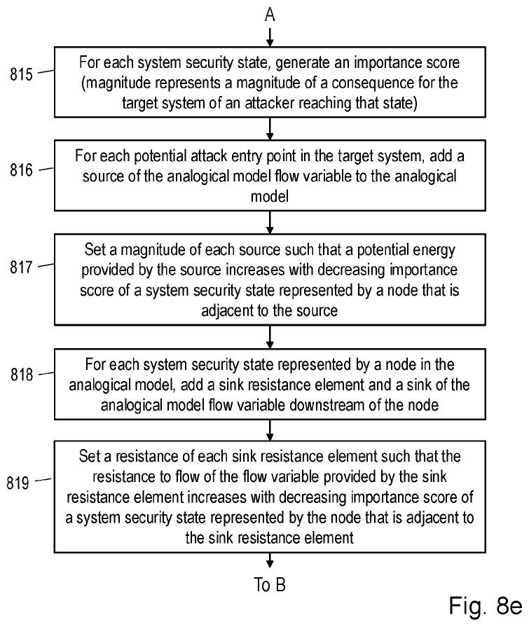

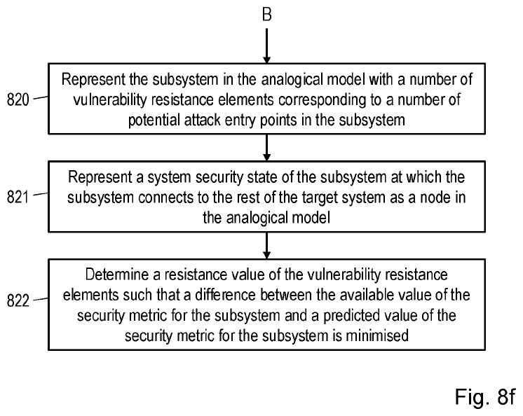

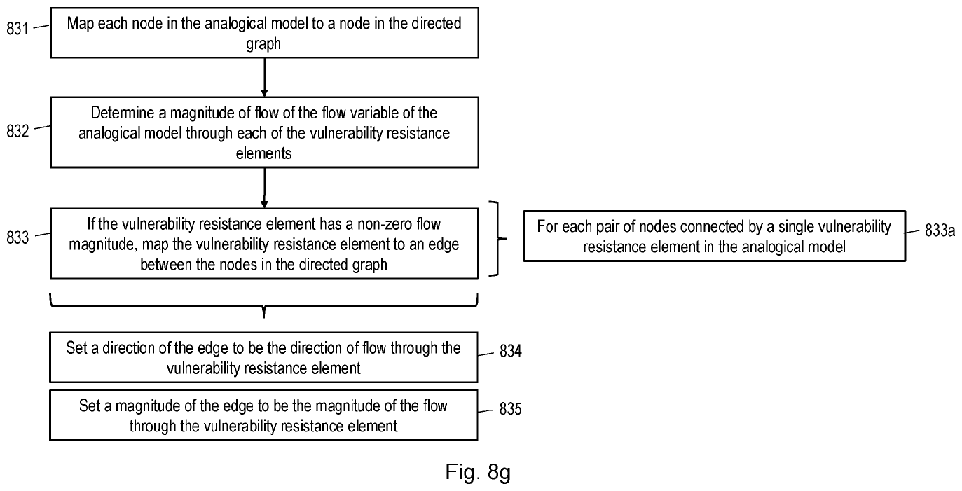

FIGS. 8a to 8g show flow charts illustrating another example of a method 800 for generating a security metric for a target system comprising a plurality of logical components. As for the method 400 discussed above, the security metric comprises a quantitative representation of the security of the target system, which representation is non-specific to any given component of the system or point of attack. The method 800 may be performed by a Prediction module, which may be operable to be instantiated in a cloud based deployment. In one for example, the Prediction module may be instantiated in a Network Functions Virtualization (NFV) Security Manager node, an example of which is illustrated in “Network Functions Virtualisation (NFV) Release 3, Security, Security Management and Monitoring specification” ETSI GS NFV-SEC 013 V3.1.1 (2017-02). For example, the method 800 may be run as a service in a Security Manager node. In other examples, the Prediction module may be instantiated in a physical or virtual server in a centralised or cloud based deployment. The method 800 illustrates examples of how the steps of the method 400 may be implemented and supplemented to provide the above discussed and additional functionality.

Referring initially to FIG. 8a, in step 810, the Prediction module generates an analogical model of the target system, the analogical model comprising a plurality of vulnerability resistance elements, each vulnerability resistance element corresponding to a security vulnerability of the target system. Steps that may be performed in order to carry out the generation of an analogical model at step 810 are illustrated in FIGS. 8d, 8e and 8f. These steps are largely similar to the steps for generating an analogical model of the reference and training systems in the method 700, and so while the steps are outlined briefly here, reference is made to the description of FIGS. 7b, 7c and 7d above for a more detailed discussion of the individual steps and how they may be implemented.

Referring initially to FIG. 8d, in order to generate the analogical model of the target system at step 810, the Prediction module may first obtain configuration information for the target system in step 811, the configuration information comprising a system topology and an identification of security vulnerabilities of the target system. The Prediction module may then generate from the configuration information a plurality of system security states in step 812, wherein each system security state comprises at least one of a pre or post condition of an identified vulnerability. As illustrated at 812a, a pre condition of a security vulnerability comprises prerequisites for the system and for an attacker that are required for an attack on the security vulnerability to be successful; and a post condition of a security vulnerability comprises the consequences for the system and for the attacker of successfully executing an attack on the security vulnerability.

In step 813, the Prediction module may, for a physical domain of the analogical model as illustrated at step 813a, represent the identified security vulnerabilities, generated system security states, and attack paths traversing vulnerabilities between system security states as follows. As discussed above, the physical domain of the analogical model may be electrical, hydraulic, linear, or rotational mechanical, etc.

Each identified security vulnerability of the target system may be represented as a vulnerability resistance element of the analogical model. As illustrated at 813b, a magnitude of the resistance provided by the vulnerability resistance element may be based on a severity of the security vulnerability. Each generated system security state may be represented as a node between two or more vulnerability resistance elements of the analogical model. Attack paths traversing vulnerabilities between system security states may be represented as flow conduits for a flow variable in the analogical model.

In step 814, the Prediction module may add a one way flow gate to each vulnerability resistance element to direct flow of the flow variable around the model in a direction consistent with the flow of attacks in the target system.

Referring now to FIG. 8e, in step 815, the Prediction module may, for each system security state represented in the analogical model, generate an importance score, wherein a magnitude of the importance score represents a magnitude of a consequence for the target system of an attacker reaching that state. In step 816, for each potential attack entry point in the target system, the Prediction module may add a source of the analogical model flow variable to the analogical model.\in step 817, the Prediction module may set a magnitude of each source such that a potential energy provided by the source increases with decreasing importance score of a system security state represented by a node that is adjacent to the source.

For each system security state represented by a node in the analogical model, the Prediction module may add a sink resistance element and a sink of the analogical model flow variable downstream of the node at step 818. The Prediction module may additionally set a resistance of each sink resistance element in step 819 such that the resistance to flow of the flow variable provided by the sink resistance element increases with decreasing importance score of a system security state represented by the node that is adjacent to the sink resistance element.

Referring now to FIG. 8f, the target system may comprise a subsystem for which a value of the security metric is available. It is possible that the network topology or other configuration information for such a subsystem may be unavailable, and consequently the subsystem may be represented in the analogical model in the following manner. In step 820, the Prediction module may represent the subsystem in the analogical model with a number of vulnerability resistance elements corresponding to a number of potential attack entry points in the subsystem. In step 821, the Prediction module may represent a system security state of the subsystem at which the subsystem connects to the rest of the target system as a node in the analogical model. Finally, at step 822, the Prediction module may determine a resistance value of the vulnerability resistance elements for the subsystem such that a difference between the available value of the security metric for the subsystem and a predicted value of the security metric for the subsystem is minimised. The predicted value may be generated using the ML model that is used in step 850 below.

Referring again to FIG. 8a, having generated the analogical model in step 810, the Prediction module then maps the generated analogical model to a directed graph of the target system. Steps that may be performed in order to carry out the mapping to a directed graph in step 830 are illustrated in FIG. 8g. These steps are largely similar to the steps for mapping an analogical model of the reference or training systems in the method 700, and so, as for the generation of the analogical model, while the steps are outlined briefly here, reference is made to the description of FIG. 7e above for a more detailed discussion of the individual steps and how they may be implemented.

Referring to FIG. 8g, the Prediction module first maps each node in the analogical model to a node in the directed graph at step 831. The Prediction module then determines a magnitude of flow of the flow variable of the analogical model through each of the vulnerability resistance elements in step 832. In step 833, for each pair of nodes connected by a single vulnerability resistance element in the analogical model (as illustrated at 833a), if the vulnerability resistance element has a non-zero flow magnitude, the Prediction module maps the vulnerability resistance element to an edge between the nodes in the directed graph. As illustrated at steps 834 and 835, the Prediction module may set a direction of the edge to be the direction of flow through the vulnerability resistance element, and set a magnitude of the edge to be the magnitude of the flow through the vulnerability resistance element.

Referring again to FIG. 8a, the Prediction module, then calculates a distance metric between the directed graph of the target system and a directed graph of each of a plurality of reference systems in step 840. As illustrated at 840a this may comprise calculating a measure of similarity between the directed graph of the target system and the directed graph of each of the plurality of reference systems. Reference is made to the calculation of a distance metric in step 740 of the method 700 for a more detailed discussion of how this step may be implemented. The distance metric may return a scalar distance or a multidimensional distance with respect to each of the reference systems. This may consequently result in a vector or a multidimensional tensor of distance metrics with respect to the plurality of reference systems.

Referring now to FIG. 8b, in step 850, the Prediction module inputs the tensor (scalar or multidimensional tensor) comprising the calculated distance metrics to a trained ML model. As illustrated at 850a and 850b, the ML model has been trained using a training data set that is based on the same plurality of reference systems, and is operable to process the input tensor and to generate an output comprising a value of the security metric for the target system. As illustrated at 850c and 850d, the ML model may have been trained using examples of the method 300 or 700, and may comprise a regression model.

In step 855, the Prediction module may provide the generated security metric to a user of the target system. The generated security metric may be used for various purposes, two of which are illustrated in the steps of FIG. 8b and FIG. 8c. For example, the target system may comprise a first target system, and the Prediction module may, in step 860, generate a security metric for a second target system comprising a plurality of logical components, and use the security metrics of the first and second target systems to select a target system for deployment in step 865. It will be appreciated that generating the security metric for the second target system may involve the same steps as for the first target system, and the trained ML model may be the same for both systems. In some examples, the first and second target systems may perform the same or similar tasks, etc.

Referring now to FIG. 8c, in another example of how the generated security metric may be used, the Prediction module may perform a series of steps for each of a candidate set of security vulnerabilities of the target system, as illustrated ay 870a. The candidate set may comprise security vulnerabilities of the system for which a patch is available, and consequently which are candidates for patching, and the steps 870 to 885 may assist with identifying a priority security vulnerability for patching. In step 870 the Prediction module amends the generated analogical model of the target system to remove a security vulnerability from the candidate set. The Prediction module then maps the amended analogical model to a new directed graph of the target system (for example following the steps 831 to 835 discussed above), in step 875. In step 880, the Prediction module calculates updated distance metrics between the updated directed graph of the target system and the directed graphs of each of the plurality of reference systems. In step 885, the Prediction module then uses the trained ML model and the updated distance metrics to obtain an updated value of the security metric for the target system.

As discussed above, the Prediction module may perform steps 870 to 885 for each of a candidate set of security vulnerabilities, before, at step 890, using the updated values of the security metric to identify a priority security vulnerability of the target system for patching. This may comprise, at step 890a, identifying from among the updated security metrics the security metric indicating the greatest improvement in system security with respect to the initially generated security metric, and, at step 890b, identifying as the priority security vulnerability of the target system, the security vulnerability that was removed from the amended analogical model for which the identified updated security metric was generated. The steps illustrated in FIG. 8c thus illustrate how the methods 400, 800 for generating a security metric may be used to guide technical and practical decisions such as which security vulnerabilities to prioritise for patching, or which available system to deploy.

As discussed above, the methods 300 and 700 may be performed by a Training module, and the present disclosure provides a Training module that is adapted to perform any or all of the steps of the above discussed methods. The Training module may comprise a physical node such as a computing device, server etc., or may comprise a virtual node. A virtual node may comprise any logical entity, such as a Virtualized Network Function (VNF) which may itself be running in a cloud, edge cloud or fog deployment. The Training module may be operable to be instantiated in a cloud based deployment. In one for example, the Training module may be instantiated in a Network Functions Virtualization (NFV) Security Manager node. In other examples, the Training module may be instantiated in a physical or virtual server in a centralised or cloud based deployment.

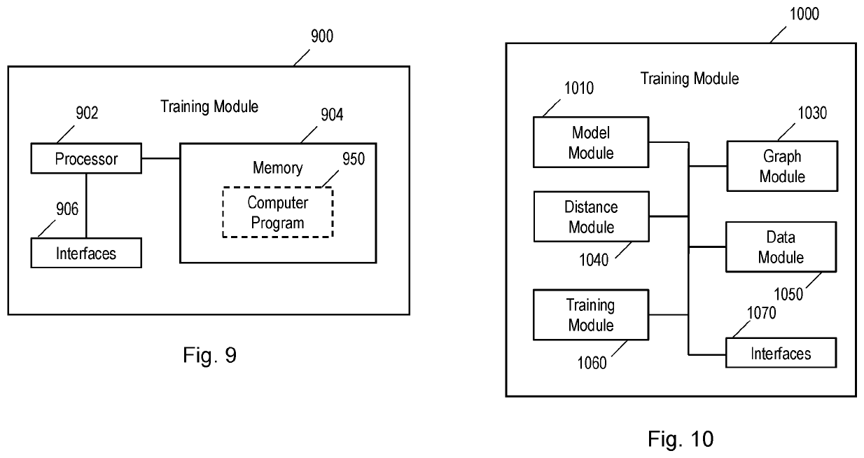

FIG. 9 is a block diagram illustrating an example Training module 900 which may implement the method 300 and/or 700, as illustrated in FIGS. 3 and 7a to 7e, according to examples of the present disclosure, for example on receipt of suitable instructions from a computer program 950. Referring to FIG. 9, the Training module 900 comprises a processor or processing circuitry 902, and may comprise a memory 904 and interfaces 906. The processing circuitry 902 is operable to perform some or all of the steps of the method 300 and/or 700 as discussed above with reference to FIGS. 3 and 7a to 7e. The memory 904 may contain instructions executable by the processing circuitry 902 such that the Training module 900 is operable to perform some or all of the steps of the method 300 and/or 700, as illustrated in FIGS. 3 and 7a to 7e. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive, etc.

FIG. 10 illustrates functional sub-modules in another example of Training module 1000 which may execute examples of the methods 300 and/or 700 of the present disclosure, for example according to computer readable instructions received from a computer program. It will be understood that the sub-modules illustrated in FIG. 10 are functional sub-modules, and may be realized in any appropriate combination of hardware and/or software. The sub-modules may comprise one or more processors and may be integrated to any degree.

Referring to FIG. 10, the Training module 1000 is for training an ML model having a plurality of trainable parameters, wherein the ML model is for generating a security metric for a target system comprising a plurality of logical components, and wherein the security metric comprises a quantitative representation of the security of the target system, which representation is non-specific to any given component of the system or point of attack. The Training module comprises a model sub-module 1010 and a graph sub-module 1030. The model sub-module 1010 and graph sub-module 1030 are for performing the steps of, for each of a plurality of reference systems, and for each of a plurality of training systems, generating an analogical model of the system, the analogical model comprising a plurality of vulnerability resistance elements, each vulnerability resistance element corresponding to a security vulnerability of the modelled system, and mapping the generated analogical model to a directed graph of the modelled system. For each of the plurality of training systems, a value of the security metric is available. The Training module further comprises a distance sub-module 1040 for calculating, for each of the plurality of training systems, a distance metric between the directed graph of the training system and the directed graph of each of the plurality of reference systems, and a data sub-module 1050 for adding to a training data set the calculated distance metrics and the security metric value for the training system. The Training module further comprises a training sub-module 1060 for using the training data set to update values of the trainable parameters of the ML model, wherein the ML model is operable to receive an input comprising a plurality of distance metrics, and to provide an output comprising a value of the security metric. The Training module 1000 may further comprise interfaces 1070, which may be operable to facilitate communication with a Prediction module, and/or with other nodes or modules, over suitable communication channels.

As discussed above, the methods 400 and 800 may be performed by a Prediction module, and the present disclosure provides a Prediction module that is adapted to perform any or all of the steps of the above discussed methods. The Prediction module may comprise a physical node such as a computing device, server etc., or may comprise a virtual node. A virtual node may comprise any logical entity, such as a Virtualized Network Function (VNF) which may itself be running in a cloud, edge cloud or fog deployment. The Prediction module may be operable to be instantiated in a cloud based deployment. In one for example, the Prediction module may be instantiated in a Network Functions Virtualization (NFV) Security Manager node. In other examples, the Prediction module may be instantiated in a physical or virtual server in a centralised or cloud based deployment.

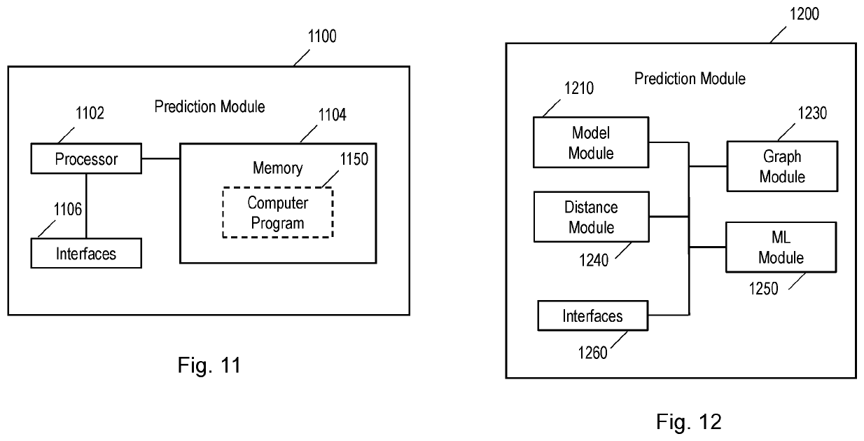

FIG. 11 is a block diagram illustrating an example Prediction module 1100 which may implement the method 400 and/or 800, as illustrated in FIGS. 4 and 8a to 8g, according to examples of the present disclosure, for example on receipt of suitable instructions from a computer program 1150. Referring to FIG. 11, the Prediction module 1100 comprises a processor or processing circuitry 1102, and may comprise a memory 1104 and interfaces 1106. The processing circuitry 1102 is operable to perform some or all of the steps of the method 400 and/or 800 as discussed above with reference to FIGS. 4 and 8a to 8g. The memory 1104 may contain instructions executable by the processing circuitry 1102 such that the Prediction module 1100 is operable to perform some or all of the steps of the method 400 and/or 800, as illustrated in FIGS. 4 and 8a to 8g. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive, etc.

FIG. 12 illustrates functional sub-modules in another example of Prediction module 1200 which may execute examples of the methods 400 and/or 800 of the present disclosure, for example according to computer readable instructions received from a computer program. It will be understood that the sub-modules illustrated in FIG. 12 are functional sub-modules, and may be realized in any appropriate combination of hardware and/or software. The sub-modules may comprise one or more processors and may be integrated to any degree.

Referring to FIG. 12, the Prediction module 1200 is for generating a security metric for a target system comprising a plurality of logical components, wherein the security metric comprises a quantitative representation of the security of the target system, which representation is non-specific to any given component of the system or point of attack. The Prediction module 1200 comprises a model sub-module 1210 for generating an analogical model of the target system, the analogical model comprising a plurality of vulnerability resistance elements, each vulnerability resistance element corresponding to a security vulnerability of the target system. The Prediction module further comprises a graph sub-module 1230 for mapping the generated analogical model to a directed graph of the target system. The Prediction module further comprises a distance sub-module 1240 for calculating a distance metric between the directed graph of the target system and a directed graph of each of a plurality of reference systems. The Prediction module further comprises an ML sub-module 1250 for inputting a tensor comprising the calculated distance metrics to a trained ML model, wherein the ML model has been trained using a training data set that is based on the same plurality of reference systems, and wherein the ML model is operable to process the input tensor and to generate an output comprising a value of the security metric for the target system. The Prediction module 1200 may further comprise interfaces 1260, which may be operable to facilitate communication with a Training module, and/or with other nodes or modules, over suitable communication channels.

FIGS. 3 to 8g discussed above provide an overview of methods which may be performed according to different examples of the present disclosure. These methods may be performed by a Training module and a Prediction module respectively, as illustrated in FIGS. 9 to 12. The methods enable the generation of a security metric for a system of logical components, which metric is generated in a data driven and repeatable manner. There now follows a detailed discussion of how different process steps illustrated in FIGS. 3 to 8f and discussed above may be implemented. The functionality and implementation detail described below is discussed with reference to the modules of FIGS. 9 to 12 performing examples of the methods 300, 400, 700 and/or 800, substantially as described above.

Implementation of the methods disclosed herein involves the building of an analogical model for a target or test system, as well as a plurality of reference and training systems. The training systems may be referred to as labelled systems, as a value for the security metric is available for these systems, either following testing or expert analysis. The generated analogical models are then mapped to directed graphs which reflect the potential flow of attacks through the systems. In some examples, it may be appropriate to select or design a distance function that is specific to the target system or to the domain of the target and reference systems, as the distance function is used to measure similarity with the reference systems, and to generate a feature tensor for input to the ML model. The feature tensors for the labelled (training) systems are used, together with the values of the security metric for these systems, to train the ML model according to the methods 300, 700. The trained model can then be used to generate a predicted value of the security metric for the target or test system.

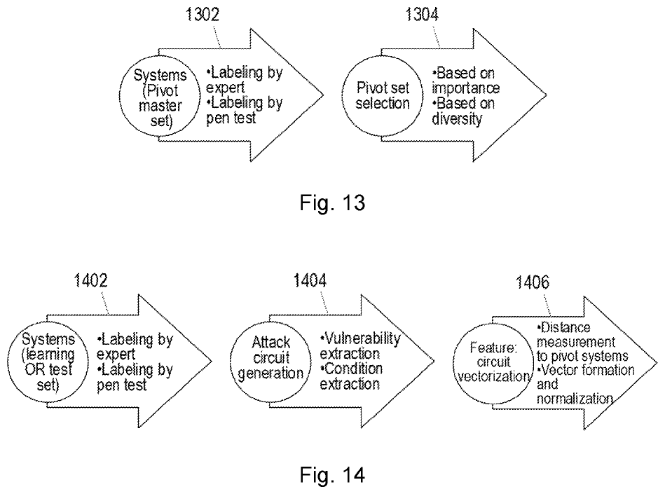

Different aspects of the above process flow are illustrated in FIGS. 13 to 17.

Selection of Reference and Training Systems (step 702 of method 700)

FIG. 13 illustrates a selection process for identifying suitable systems to be included within the plurality of reference systems for methods according to the present disclosure. FIG. 13 illustrates reference systems for which a value of the security metric is available, from testing or analysis. However, it will be appreciated that in some examples it may be that labelled values of the security metric are in fact only available for the training systems, which may also be selected according to the process of FIG. 13.

The reference systems (also referred to as pivot systems) serve as a benchmark, as the position of a target system within the search space is determined by measuring the similarity of that system to the reference systems. The reference systems should be sufficiently diverse to capture and represent variety of systems in the search space. Reference systems should also be relatively important within the search space and relatively well understood within the domain, which may be telecommunications, Cloud computing, Web Services, or some other domain in which systems of logical components are deployed_{[GR2][FFM3]}. It is desirable that, at least for selection of the training systems, a consensus among experts about value of the security metric should exist.

Referring to FIG. 13, in step 1302, systems are labelled with a value of a security metric. In step 1304, the plurality of reference and/or training systems is selected from amongst the labelled systems according to the criteria of diversity of representation across the plurality of systems, and importance and consensus regarding individual systems.

Feature Engineering (steps 310-340 of method 300, 410-440 of method 400, 710-740 of method 700, and 810-840 of method 800)

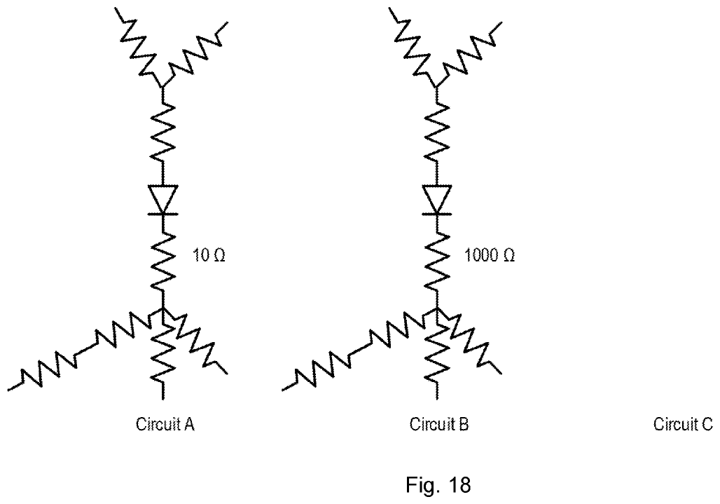

Feature engineering, illustrated in FIG. 14, encompasses the steps of generating an analogical model of the systems, mapping the model to a directed graph, and calculating a distance function between the directed graph of a target or training system, and the directed graphs of each of the reference systems. These steps are represented in FIG. 14 and are also discussed in greater detail below, with reference to FIGS. 18 to 21.

Referring to FIG. 14, for the reference or training systems, in step 1402 labels in the form of values of the security metric are obtained for relevant systems as discussed above. In step 1404, the analogical model is generated. In FIG. 14 the example of the electrical domain is illustrated, and so the analogical model is referred to as an attack circuit. In order to generate the model, a list of security vulnerabilities and any other related information that can affect the security level assessment of a system may be extracted, for example from configuration information for the system. Based on this information, pre and post conditions for the security vulnerabilities can be extracted, allowing for the generation of the attack circuit, as discussed above with reference to FIGS. 7b to 7d, and 8d to 8f. The attack circuit is then mapped to a directed graph to enable the appropriate distance calculations (with respect to each of the reference systems) to be carried out. The generation of an attack circuit (or more generally an analogical model) and mapping to a directed graph are discussed in greater detail below. The results of the distance calculations may then be assembled and normalised into a feature vector (or multi-dimensional tensor) in step 1406.

### Building and Training ML Regression Model (Step 360 of Method 300 and 760 of Method 700)

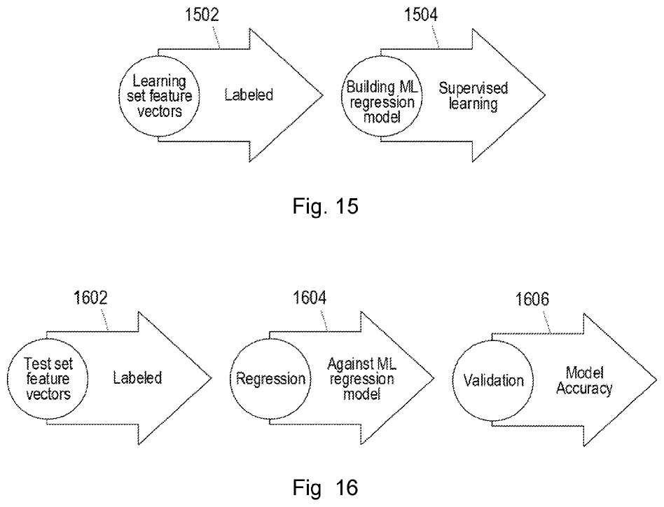

In order to train the ML model, and referring to FIG. 15, in step 1502, the security metric value of each of the training systems is assigned to the appropriate feature vector or tensor as its labelled output. In step 1504, any of the ML regression methodologies mentioned above may be used to train an ML model for determining a value of the security metric for a target system based on the similarity of the directed graph of the target system to the directed graphs of each of the reference systems.

### ML Model Validation

FIG. 16 illustrates ML model validation, which may be performed according to known methods in order to evaluate the accuracy of the trained model. For example, a portion of labelled systems not used for training may be selected in step 1602 as testing systems, and input to the trained ML model in step 1604, in order to obtain predicted values of the security metric. These predicted values, together with the labelled values of the testing systems, may be used to assess the accuracy of the ML model, for example by calculating a loss function based on the predicted and labelled values.

### Use of the ML Model to Generate Security Metric Values (Step 450 of Method 400 and Step 850 of Method 800)

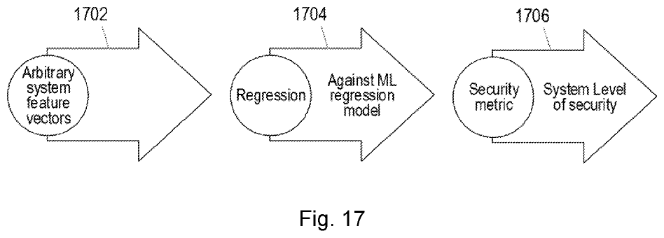

FIG. 17 illustrates use of the trained ML model to generate a value of a security metric for a target system. The feature vector or tensor for the target system is obtained at step 1702 as discussed above, and input to the ML model at step 1704 in order to generate the predicted value of the security metric at step 1706.

### Generating an Analogical Model and Mapping to a Directed Graph

An example process for generating an analogical model and mapping to a directed graph is discussed in detail above with reference to FIGS. 7b to 7d. FIG. 18 is an example illustration of why this method provides a more reliable representation of security of the modelled system than alternative processes. For example, the model could be mapped by simply including an edge in the directed graph for every vulnerability resistance element, with an edge weight that is based on the resistance value (edge weight of the resistance value, or inverse of the resistance value). However, this mapping does not provide the same representation of security of the modelled system, as discussed below.

FIG. 18 illustrates analogical models of three different systems. Each model is based on the electrical domain, and so is referred to as an attack circuit. It will be appreciated that while circuit A and circuit B share a high visual and topological resemblance, if the focus is on the possible flow of current through the circuits, it is circuit A and circuit C that are in fact the most similar. Flow of current through the attack circuits represents flow of attacks through the systems, and so it is the flow of current that provides the best representation of the security of the systems. The method presented above, and discussed in additional detail below, for mapping an analogical model to a directed graph has the effect of representing, via edges in the directed graph, not just the security vulnerabilities of the system but the flow of the flow variable of the analogical model (and so the flow of attacks in the modelled system). Graph similarity of such graphs thus provides the most accurate representation of similarity of security level between different systems.

As discussed above, it is desirable for the analogical model to be non specific to any particular target component or attack entry point. In order to generalise the analogical model while still being able to generate flow of the flow variable, examples of the present disclosure introduce the concept of an importance score for system security states, and the use of flow variable sources and sinks for each potential attack entry point and each potential target (steps 715 to 719 of method 700, and steps 815 to 819 of method 800).

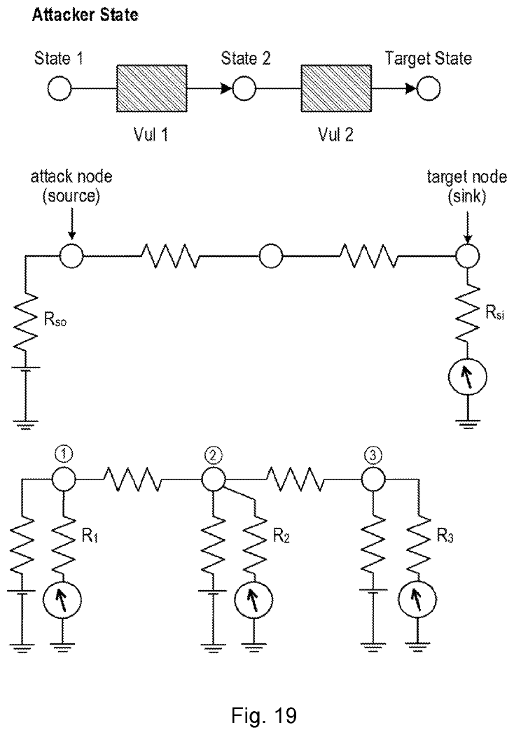

Referring to the electrical domain, without a specific target system security state, it is not possible to know where to ground the attack circuit. However, using the importance score, which represents a magnitude of a consequence for the system of an attacker reaching that state, it is possible to attach a power source and grounded resistor to all the system security states (circuit nodes). For those nodes having a lower importance score, the power source may have a higher voltage (capable of producing more current) and the resistor may also be larger (making it harder to lose the current). Conversely, for those nodes having a higher importance score, the power source may have a lower voltage (less capable of producing current), and the resistor may also be smaller (making it easier to lose current). With the addition of power sources and grounded resistors (sources and sinks of flow variable), the analogical model can be solved to determine a specific current (representing flow of attacks) that is flowing in each vulnerability resistance element (representing the security vulnerabilities). FIG. 19 illustrates an attack graph, initial analogical model (attack circuit), and analogical model with the addition of power sources and grounded resistors as discussed. In the attack graph at the top of FIG. 19, three system security states are illustrated: state 1, which is the attacker state, an intermediate state labelled state 2, and state 3, which is the target state. The system security states are separated by first and second security vulnerabilities. In the initial analogical model (attack circuit) of the system represented by the attack graph, shown in the middle of FIG. 19, the security vulnerabilities are represented as electrical resistors, and a source and sink of electrical current are added to the initial and target states. Illustrated at the bottom of FIG. 19 is the analogical model with the addition of power sources and grounded resistors for each node (system security state). The values of R₁, R₂ and R₃ are selected on the basis of the importance score of the respective system security state. For example, if system security state 3 has a higher importance score than system security state 2, then the value of R3 will be less than the value of R₂.

Mapping of the analogical model focuses on vulnerability resistance elements (resistors) in which current is flowing, with each resistor in which current is flowing mapped to an edge in the directed graph. Each edge in the directed graph has a direction and edge weight that is determined by the direction and magnitude of current flow through the resistor (regardless of the resistance value of the resistor). All other components in the analogical model, such as one way gates, sources and sinks of flow variable and their associated source and sink resistance elements etc., can be omitted from the directed graph. The impact of these omitted elements is reflected in the flow of the flow variable through the vulnerability resistance elements, and this is represented in the edges of the directed graph.

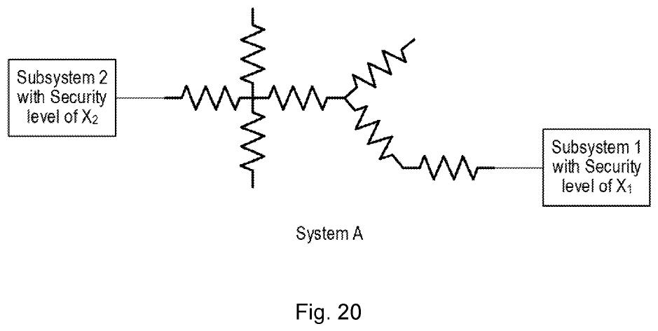

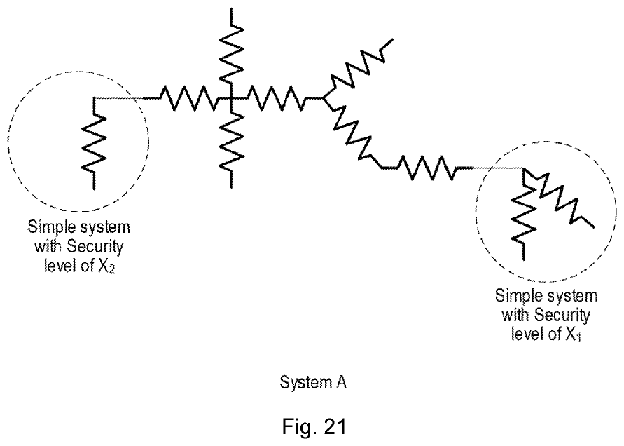

In some situations, it may be envisaged that access to the full detail of a subsystem of the modelled system may not be available. It may also be the case that the subsystem has already been analysed or tested, meaning that a value of the security metric is available for the subsystem. In such cases, the subsystem may be represented in the analogical model with a simple model that produces the same level of security. FIG. 20 shows a system with a main part and two subsystems for which no configuration data is available, but for which a measured or analysed value of their security metric is available. These values are illustrated as X₁ and X₂. In FIG. 21, the two subsystems have been replaced. In order to replace each subsystem, a number of vulnerability resistance elements may be introduced that corresponds to the number of potential attack entry points in the subsystem. Thus, for subsystem 1, two vulnerability resistance elements are introduced, while for subsystem 2, only a single resistance element is shown. A system security state of the subsystem at which the subsystem connects to the rest of the target system is then represented as a node in the analogical model.

Finally, a resistance value of the vulnerability resistance elements for the subsystems is determined, such that a difference between the available value of the security metric for the subsystem and a predicted value of the security metric for the subsystem is minimised. The predicted value may be generated using the ML model that is trained in emtho0ds 300, 700 and used in methods 400, 800. The subsystems are then fully represented in the analogical model, which can be solved for flow in the vulnerability resistance elements and mapped to a directed graph as discussed above.

### Use Cases

It will be appreciated that a data driven and repeatable method for generating a security metric as disclosed herein may serve a range of different purposes in the selection, deployment, management, updating and troubleshooting of systems of logical components. Two possible use cases are discussed above with reference to the method 800. The first of these is the use of the security metric to compare different systems in order to select a preferred system for deployment. It will be appreciated that if system products are labelled with a security level which is data driven, and consequently repeatable and can be standardised, this may significantly aid consumers of such systems to compare products from different vendors and to select the most appropriate system for their technical requirements.

Another use case discussed above is the prioritisation of security vulnerabilities for patching. There is a cost associated with patching of any security vulnerability, and examples of the present disclosure can be used to indicate, quickly and without the need for expensive testing or human analysis, which vulnerability should be patched as a priority in order to provide the greatest improvement in overall security of the system. The methods of the present disclosure may also assist with identifying any vulnerabilities, the patching of which would provide negligible improvement to overall security, and consequently which are not worth the cost of patching.

In addition, it will be appreciated that penetration testing or detailed analysis by domain experts is not feasible to incorporate within the software development cycle of system products, owing to practical constraints, expense, and time. In contrast, the methods disclosed herein lend themselves well to integration into the software development cycle, allowing for regular testing of the security impact of different design and development choices (component selection and placement for example), and contributing to progress towards systems which are “secure by design”.

Examples of the present disclosure thus provide data driven methods for generation of a security metric for a target system that provides a quantitative representation of the security of the target system, which representation is non-specific to any given component of the system or point of attack. The methods involve generation of an analogical model of the target system, and mapping of the analogical model to a directed graph. A distance metric is then calculated between the directed graph of the target system and directed graphs of a plurality of reference systems. Owing to the manner in which the directed graphs are created, the distance metric provides a measure of similarity between the overall security of the target system and that of the plurality of reference systems. The distance metric with respect to each of the reference systems can then be input to a trained ML model in order to generate a value of the security metric for the target system. The ML model is trained using a plurality of training systems, for which a value of the security metric is available, and the same plurality of reference systems as will be used for the target system.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1-42. (canceled)

43. A computer implemented method for training a Machine Learning (ML) model having a plurality of trainable parameters, wherein the ML model is for generating a security metric for a target system comprising a plurality of logical components, and wherein the security metric comprises a quantitative representation of the security of the target system, which representation is non-specific to any given component of the system or point of attack, the method comprising:
for each of a plurality of reference systems, and for each of a plurality of training systems:
generating an analogical model of the system, the analogical model comprising a plurality of vulnerability resistance elements, each vulnerability resistance element corresponding to a security vulnerability of the modelled system; and
mapping the generated analogical model to a directed graph of the modelled system;
wherein for each of the plurality of training systems, a value of the security metric is available;
the method further comprising, for each of the plurality of training systems:
calculating a distance metric between the directed graph of the training system and the directed graph of each of the plurality of reference systems; and
adding to a training data set the calculated distance metrics and the security metric value for the training system; and
the method further comprising:
using the training data set to update values of the trainable parameters of the ML model, wherein the ML model is operable to receive an input comprising a plurality of distance metrics, and to provide an output comprising a value of the security metric.

44. The method of claim 43, wherein generating the analogical model of the system comprises:
obtaining configuration information for the system, the configuration information comprising a system topology and an identification of security vulnerabilities of the system;
generating from the configuration information a plurality of system security states, wherein each system security state comprises at least one of a pre or post condition of an identified vulnerability; and
for a physical domain of the analogical model, representing:
each identified security vulnerability of the system as a vulnerability resistance element of the analogical model;
each generated system security state as a node between two or more vulnerability resistance elements of the analogical model; and
attack paths traversing vulnerabilities between system security states as flow conduits for a flow variable in the analogical model.

45. The method of claim 44, wherein a precondition of a security vulnerability comprises prerequisites for the system and for an attacker that are required for an attack on the security vulnerability to be successful; and wherein a post condition of a security vulnerability comprises the consequences for the system and for the attacker of successfully executing an attack on the security vulnerability.

46. The method of claim 43, wherein, for generating the analogical model of a system, the method further comprises adding a one way flow gate to each vulnerability resistance element to direct flow of a flow variable around the model in a direction consistent with the flow of attacks in the system.

47. The method of claim 43, wherein a magnitude of the resistance provided by each vulnerability resistance element is based on a severity of the corresponding security vulnerability.

48. The method of claim 43, wherein, for each system security state represented in the analogical model, the method includes generating an importance score, wherein a magnitude of the importance score represents a magnitude of a consequence for the modelled system of an attacker reaching that state.

49. The method of claim 43, wherein, for generating the analogical model of the system, the method includes, for each potential attack entry point in the modelled system, adding a source of the analogical model flow variable to the analogical model.

50. The method of claim 49, further comprising setting a magnitude of each source such that a potential energy provided by the source increases with decreasing importance score of a system security state represented by a node that is adjacent to the source.

51. The method of claim 43, wherein, for each system security state represented by a node in the analogical model, the method includes adding a sink resistance element and a sink of the analogical model flow variable downstream of the node.

52. The method of claim 51, further comprising setting a resistance of each sink resistance element such that the resistance to flow of the flow variable provided by the sink resistance element increases with decreasing importance score of a system security state represented by the node that is adjacent to the sink resistance element.

53. The method of claim 43, wherein at least one of the plurality of reference systems or the plurality of training systems comprises a subsystem for which a value of the security metric is available, and wherein generating the analogical model of the system includes:
representing the subsystem in the analogical model with a number of vulnerability resistance elements corresponding to a number of potential attack entry points in the subsystem;
representing a system security state of the subsystem at which the subsystem connects to the rest of the modelled system as a node in the analogical model; and
determining a resistance value of the vulnerability resistance elements such that a difference between the available value of the security metric for the subsystem and a predicted value of the security metric for the subsystem is minimised.

54. The method of claim 43, wherein mapping a generated analogical model to a directed graph of a modelled system comprises:
mapping each node in the analogical model to a node in the directed graph;
determining a magnitude of flow of the flow variable of the analogical model through each of the vulnerability resistance elements; and
for each pair of nodes connected by a single vulnerability resistance element in the analogical model:
if the vulnerability resistance element has a non-zero flow magnitude, mapping the vulnerability resistance element to an edge between the nodes in the directed graph.

55. The method of claim 54, wherein mapping the vulnerability resistance element to an edge between the nodes in the directed graph comprises:
setting a direction of the edge to be the direction of flow through the vulnerability resistance element; and
setting a magnitude of the edge to be the magnitude of the flow through the vulnerability resistance element.

56. The method of claim 43, wherein calculating the distance metric between the directed graph of the training system and the directed graph of each of the plurality of reference systems comprises:
calculating a measure of similarity between the directed graph of the training system and the directed graph of each of the plurality of reference systems.

57. The method of claim 43, wherein the ML model comprises a regression model.

58. The method of claim 43, further comprising:
selecting at least the plurality of reference systems such that the plurality fulfils a diversity criterion with respect to the domain of systems for which the trained ML model is to be used; and such that individual systems in the plurality fulfil:
a significance criterion with respect to the domain of systems for which the trained ML model is to be used; and
a consensus criterion with respect to the value of a security metric that is available for the system.

59. A computer implemented method for generating a security metric for a target system comprising a plurality of logical components, wherein the security metric comprises a quantitative representation of the security of the target system, which representation is non-specific to any given component of the system or point of attack, the method comprising:
generating an analogical model of the target system, the analogical model comprising a plurality of vulnerability resistance elements, each vulnerability resistance element corresponding to a security vulnerability of the target system;
mapping the generated analogical model to a directed graph of the target system;
calculating a distance metric between the directed graph of the target system and a directed graph of each of a plurality of reference systems; and
inputting a tensor comprising the calculated distance metrics to a trained Machine Learning (ML) model;
wherein the ML model has been trained using a training data set that is based on the same plurality of reference systems; and
wherein the ML model is operable to process the input tensor and to generate an output comprising a value of the security metric for the target system.

60. The method of claim 59, wherein generating the analogical model of the target system comprises:
obtaining configuration information for the target system, the configuration information comprising a system topology and an identification of security vulnerabilities of the target system;
generating from the configuration information a plurality of system security states, wherein each system security state comprises at least one of a pre or post condition of an identified vulnerability; and
for a physical domain of the analogical model, representing:
each identified security vulnerability of the target system as a vulnerability resistance element of the analogical model;
each generated system security state as a node between two or more vulnerability resistance elements of the analogical model; and
attack paths traversing vulnerabilities between system security states as flow conduits for a flow variable in the analogical model.

61. The method of claim 59, wherein a precondition of a security vulnerability comprises prerequisites for the system and for an attacker that are required for an attack on the security vulnerability to be successful; and wherein a post condition of a security vulnerability comprises the consequences for the system and for the attacker of successfully executing an attack on the security vulnerability.

62. The method of claim 59, wherein, for generating an analogical model of the target system, the method includes further comprises adding a one way flow gate to each vulnerability resistance element to direct flow of the flow variable around the model in a direction consistent with the flow of attacks in the target system.

63. The method of claim 59, wherein a magnitude of the resistance provided by each vulnerability resistance element is based on a severity of the corresponding security vulnerability.

64. The method of claim 59, wherein, for generating the analogical model of the target system, the method includes, for each system security state represented in the analogical model, generating an importance score, wherein a magnitude of the importance score represents a magnitude of a consequence for the target system of an attacker reaching that state.

65. The method of claim 59, wherein, for generating the analogical model of the target system, the method includes, for each potential attack entry point in the target system, adding a source of the analogical model flow variable to the analogical model.

66. The method of claim 59, wherein, for generating the analogical model of the target system, the method includes, for each system security state represented by a node in the analogical model, adding a sink resistance element and a sink of the analogical model flow variable downstream of the node.

67. The method of claim 66, when dependent on claim 23, further comprising setting a resistance of each sink resistance element such that the resistance to flow of the flow variable provided by the sink resistance element increases with decreasing importance score of a system security state represented by the node that is adjacent to the sink resistance element.

68. A Training module for training a Machine Learning (ML) model having a plurality of trainable parameters, wherein the ML model is for generating a security metric for a target system comprising a plurality of logical components, and wherein the security metric comprises a quantitative representation of the security of the target system, which representation is non-specific to any given component of the system or point of attack, the training module comprising processing circuitry configured to:
for each of a plurality of reference systems, and for each of a plurality of training systems:
generate an analogical model of the system, the analogical model comprising a plurality of vulnerability resistance elements, each vulnerability resistance element corresponding to a security vulnerability of the modelled system; and
map the generated analogical model to a directed graph of the modelled system;
wherein for each of the plurality of training systems, a value of the security metric is available;
the processing circuitry being further configured to, for each of the plurality of training systems:
calculate a distance metric between the directed graph of the training system and the directed graph of each of the plurality of reference systems; and
add to a training data set the calculated distance metrics and the security metric value for the training system;
the processing circuitry being further configured to use the training data set to update values of the trainable parameters of the ML model, wherein the ML model is operable to receive an input comprising a plurality of distance metrics, and to provide an output comprising a value of the security metric.

69. A Prediction module for generating a security metric for a target system comprising a plurality of logical components, wherein the security metric comprises a quantitative representation of the security of the target system, which representation is non-specific to any given component of the system or point of attack, the prediction module comprising processing circuitry configured to:
generate an analogical model of the target system, the analogical model comprising a plurality of vulnerability resistance elements, each vulnerability resistance element corresponding to a security vulnerability of the target system;
map the generated analogical model to a directed graph of the target system;
calculate a distance metric between the directed graph of the target system and a directed graph of each of a plurality of reference systems; and
input a tensor comprising the calculated distance metrics to a trained ML model;
wherein the ML model has been trained using a training data set that is based on the same plurality of reference systems, and wherein the ML model is operable to process the input tensor and to generate an output comprising a value of the security metric for the target system.
